(19) United States
(12) Patent Application Publication
(10) Pub. No.: US 2003/0060987 A1
(43) Pub. Date: Mar. 27, 2003

(54) Systems and methods for estimation and analysis of mechanical property data associated with indentation testing

(76) Inventors: Ming Dao, Chestnut Hill, MA (US); Nuwong Chollacoop, Boston, MA (US); Krystyn J. Van Vliet, Watertown, MA (US); Thandampalayam A. Venkatesh, Cambridge, MA (US); Subra Suresh, Wellesley, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/093,946

(22) Filed: Mar. 7, 2002

Related U.S. Application Data
(60) Provisional application No. 60/273,852, filed on Mar. 7, 2001.

(51) Int. Cl. G06F 19/00

(52) U.S. Cl. 702/42

(57) ABSTRACT

Systems and methods are disclosed that can provide estimates of elasto-plastic properties of material samples using data from instrumented indentation tests. Alternatively, or in addition, estimated load-depth curves can be constructed by certain methods and systems provided based on known mechanical properties. Some disclosed systems and methods use large deformation theory for at least part of the analysis and/or determinations and/or may account for strains of at least 5% in the area of contact between the indenter and the material sample, which can result in more accurate estimates of mechanical properties and/or deformation behavior.

This application claims the benefit of the filing date under 35 U.S.C. §119 of U.S. Provisional Application Serial No. 60/273,852 filed Mar. 7, 2001, hereby incorporated by reference in its entirety.

### FIELD OF THE INVENTION

The present invention relates generally to determining or testing mechanical properties of materials, and more particularly to analyzing and/or simulating indentation testing data to determine mechanical properties such as Young's modulus, hardness, yield strength, and the strain hardening exponent.

### DESCRIPTION OF THE RELATED ART

The mechanical characterization of materials has long been represented by their hardness values. (Tabor, D., 1951, Hardness of Metals, Clarendon Press, Oxford, hereinafter “Tabor, 1951”; Tabor, D., 1970, Rev. Phys. Technol., 1, 145). Recent technological advances have led to the general availability of depth-sensing instrumented micro- and nano-indentation experiments and equipment (e.g., Tabor, 1951). Nanoindenters can provide accurate measurements of the continuous variation of indentation load P down to micro-Newtons, as a function of an indentation depth h down to nanometers. Experimental investigations of indentation have been conducted on many material systems to estimate hardness and other mechanical properties and/or residual stresses (e.g., Doerner, M. F., and Nix, W. D., 1986, J. Mater. Res., 1, 601, hereinafter “Doerner and Nix”; Pharr, G. M., and Cook, R. F., 1990, J. Mater. Res., 5, 847, hereinafter “Pharr and Cook”; Oliver, W. C., and Pharr, G. M., 1992, J. Mater. Res., 7, 1564, hereinafter “Oliver and Pharr”).

Concurrently, comprehensive theoretical and computational studies have emerged to elucidate the contact mechanics and deformation mechanisms in order to systematically estimate material properties from P versus h curves obtained from instrumented indentation (e.g., Doerner, Pharr, and Oliver). For example, the hardness and Young's modulus can be obtained from the maximum load and the initial unloading slope using the methods suggested by Oliver and Pharr or Doerner and Nix. The elastic and plastic properties may be computed through a procedure proposed by Giannakopoulos and Suresh in U.S. Pat. No. 6,134,954 (see also, Giannakopoulos, A. E., and Suresh, S., 1999, Scripta Mater., 40, 1191), and the residual stresses may be determined by the method of Suresh and Giannakopoulos in U.S. Pat. No. 6,155,104 (Suresh, S., and Giannakopoulos, A. E., 1998, Acta mater., 46, 5755). Thin film systems have also been studied using finite element computations (Bhattacharya, A. K., and Nix, W. D., 1988, Int. J. Solids Structures, 24, 881; Laursen, T. A., and Simo, J. C., 1992, J. Mater. Res., 7, 618; Tunvisut, K., O'Dowd, N. P., and Busso, E. P., 2001, Int. J. Solids Structures, 38, 335).

Using the known concept of self-similarity, simple but general results of elasto-plastic indentation response have been obtained for both spherical indentation (Hill, R., Storakers, B., and Zdunek, A. B., 1989, Proc. Roy. Soc. Lond., A423, 301) and sharp (i.e., Berkovich and Vickers) indentation. (Giannakopoulos, A. E., Larsson, P.-L., and Vestergaard, R., 1994, Int. J. Solids Structures, 31, 2679; Larsson, P.-L., Giannakopoulos, A. E., Soderlund, E., Rowcliffe, D. J., and Vestergaard, R., 1996, Int. J. Solids Structures, 33, 221, hereinafter “Larsson et al.”). More recently, scaling functions were applied to study bulk (Cheng, Y. T., and Cheng, C. M., 1998, J. Appl. Phys., 84, 1284; Cheng, Y. T., and Cheng, C. M., 1998, Appl. Phys. Lett., 73, 614; Cheng, Y. T., and Cheng, C. M., 1999, J. Mater. Res., 14, 3493) and coated material systems (Tunvisut, K., O'Dowd, N. P., and Busso, E. P., 2001, Int. J. Solids Structures, 38, 335). Kick's Law (i.e., P=Ch² during loading, where loading curvature C is a material constant) was found to be a natural outcome of the dimensional analysis of sharp indentation (e.g. Cheng, Y. T., and Cheng, C. M., 1998, J. Appl. Phys., 84, 1284).

While the above-mentioned and other methods and apparatus for determining mechanical properties of materials from indentation test data represent, in some instances, useful tools in the art of mechanical property determination, there remains a need in the art to provide improved methods and systems to accurately determine mechanical property values and/or predict mechanical deformation behavior for materials under conditions characterized by large deformation strains. Certain embodiments of the present invention address one or more of the above needs.

### SUMMARY OF THE INVENTION

Systems, methods, and software products are disclosed that can provide estimates of elasto-plastic properties of material samples using data from instrumented indentation tests. Alternatively, or in addition, estimated load-depth curves can be constructed by certain methods, software products and systems provided based on known or predetermined mechanical properties. Some disclosed systems, methods, and software products use large deformation theory for at least part of the analysis and/or determination of mechanical property data and/or behavior and/or may account for strains of at least 5% in the area of contact between the indenter of an indentation test apparatus and the material sample, which can result in more accurate estimates of mechanical properties and/or deformation behavior.

In one aspect the invention involves a series of methods. In one embodiment, a method is disclosed comprising steps of providing data from at least one indentation test on a material and determining a value for at least one mechanical property of the material from the data, wherein in the determination, strains of at least 5% that are in the material under an area of contact are accounted for.

In another embodiment, a method for facilitating the determination of at least one mechanical property of a material is disclosed. The method comprises providing a computer implemented system configured to receive load and depth data from an indentation testing apparatus and to determine a value for at least one mechanical property of the material from the data by a process that accounts for strains of at least 5% in an area of indentation of the material.

In yet another embodiment, a method for facilitating the determination of at least one mechanical property of a material is disclosed. The method comprises providing a software product including a computer readable medium on which is encoded a sequence of software instructions which, when executed, direct the computer to receive load and depth data from an indentation testing apparatus and to determine a value for the at least one mechanical property of the material from the data by a process that accounts for strains of at least 5% in an area of indentation of the material.

In another embodiment, a method is disclosed comprising steps of providing at least one mechanical property value for a material and determining load-depth data that can be used to predict load-depth behavior during a loading and unloading cycle for an indentation test on a sample of material having the at least one mechanical property value, wherein in the determination, strains of at least 5% that are in the material under an area of contact are accounted for.

In yet another embodiment, a method is disclosed comprising steps of providing data from at least one indentation test on the material and determining a value for at least one mechanical property of the material from the data, wherein the determination utilizes relationships derived from a simulation of load-depth data based at least in part on large deformation theory.

In another embodiment, a method is disclosed comprising steps of providing at least one mechanical property value for a material and determining load-depth data that can be used to predict load-depth behavior during a loading and unloading cycle for an indentation test on a sample of material having the at least one mechanical property value, wherein in the determination relationships are utilized that are derived from a simulation of load-depth data based at least in part on large deformation theory.

In yet another embodiment, a method is disclosed comprising steps of providing data from at least one indentation test in which a contact load is applied between a sample of material and an indenter over an area of contact, and determining a value for at least one mechanical property of the material without calculating or measuring the area of contact.

In another embodiment, a method is disclosed comprising steps of providing at least one mechanical property value of a material and determining load-depth data that can be used to predict load-depth behavior during a loading and unloading cycle for an indentation test in which load is applied over an area of contact to a sample of material having the at least one mechanical property value without calculating or measuring the area of contact.

In yet another embodiment, a method is disclosed comprising steps of providing data from at least one indentation test on a material and determining an estimated value of yield strength from the data that differs from an actual value of the yield strength of the material by a factor of no greater than two.

In another aspect, the invention involves systems and computer implemented systems. In one embodiment, a system is disclosed that comprises a computer implemented system configured to receive load and depth data from an indentation test involving an indentation testing apparatus that is configured to measure a contact load and a displacement between an indenter and a sample, the computer implemented system being further configured to determine a value for at least one mechanical property of the material from the data by a process that accounts for strains of at least 5% in an area of indentation of the material.

In another embodiment, a computer implemented system is disclosed. The computer implemented system comprises an acquisition module having an input for receiving values of at least one mechanical property, and an analysis module having an input for receiving the value of the at least one mechanical property from the output of the acquisition module and an output providing signals indicative of load-depth behavior during a loading and unloading cycle of an indentation test on a material, wherein the analysis module accounts for strains of at least 5% in an area of indentation of the material.

In yet another embodiment, a system is disclosed comprising a computer implemented system configured to accept load and depth data from an indentation test involving an indentation testing apparatus that is configured to measure a contact load and depth between an indenter and the sample, the computer implemented system being further configured to determine a value for at least one mechanical property of the material from the data by a process that utilizes relationships derived from a simulation of load-depth data based at least in part on large deformation theory.

In another embodiment, a computer implemented system for computing a value for a mechanical property of a material is disclosed. The system comprises input means for receiving values of load between an indenter and a material sample and depth of penetration of the indenter into the material sample and means for determining a value for at least one mechanical property of the material, the means for determining utilizing relationships derived from a simulation of load-depth data based at least in part on large deformation theory.

In yet another embodiment, a computer implemented system is disclosed comprising input means for receiving at least one mechanical property value for a material and means for determining load-depth data that can be used to predict load-depth behavior during a loading and unloading cycle for an indentation test on a sample of material having the at least one mechanical property value, wherein the determination utilizes relationships derived from a simulation of load-depth data based at least in part on large deformation theory.

In another aspect, the invention involves a series of software products. In one embodiment, a software product is disclosed including a computer readable medium on which is encoded a sequence of software instructions which, when executed, directs performance of a method comprising determining a value for at least one mechanical property of a material from data provided from at least one indentation test on the material, wherein in the determination, strains of at least 5% that are in the material under an area of contact are accounted for.

In another embodiment, a software product is disclosed including a computer readable medium on which is encoded a sequence of software instructions, which, when executed, directs performance of a method comprising determining load-depth data that can be used to predict load-depth behavior during a loading and unloading cycle for an indentation test on a sample of material having at least one predetermined mechanical property value, wherein in the determination, strains of at least 5% that are in the material under an area of contact are accounted for.

In yet another embodiment, a software product is disclosed including a computer readable medium on which is encoded a sequence of software instructions which, when executed, directs performance of a method comprising determining a value for at least one mechanical property of a material from data from at least one indentation test on the material, wherein the determination utilizes relationships derived from a simulation of load-depth data based at least in part on large deformation theory.

In another embodiment, a software product is disclosed including a computer readable medium on which is encoded a sequence of software instructions which, when executed, directs performance of a method comprising determining an estimated value of yield strength from data provided from an indentation test on a material, wherein the estimated value differs from an actual value of yield strength of the material by a factor of no greater than two.

Other advantages, novel features, and uses of the invention will become more apparent from the following detailed description of the invention when considered in conjunction with the accompanying drawings, which are schematic and which are not intended to be drawn to scale. In the figures, each identical, or substantially similar component that is illustrated in various figures as typically represented by a single numeral or notation. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

FIG. 1 is a schematic representation of an illustrative indentation apparatus;

FIG. 2 shows an example load-depth response of an elasto-plastic material to sharp indentation;

FIG. 3 is a schematic of a true stress-strain curve approximated by a power law description;

FIG. 4a shows a schematic of a conical indenter;

FIG. 4b shows a mesh design for axisymmetric computational simulations;

FIG. 4c shows an overall mesh design for an example indentation;

FIG. 4d shows a more detailed illustration of the area that directly contacts an indenter tip in FIG. 4c;

FIG. 5 shows an illustrative comparison of small deformation theory and large deformation theory;

FIG. 6 shows alternate paths for constructing dimensionless functions;

FIG. 7 shows dimensionless function π₁ using three different values of representative strain (εᵣ);

FIG. 8 shows computed data and dimensionless function π₂;

FIG. 9 shows computed data and dimensionless function π₃;

FIG. 10 shows computed data and dimensionless function π₄;

FIG. 11 shows computed data and dimensionless function π₅;

FIG. 12 is an illustrative flow chart for a forward algorithm;

FIG. 13 is an illustrative flow chart for a reverse algorithm;

FIG. 14 is another illustrative flow chart for a reverse algorithm;

FIG. 15 is another illustrative flow chart for a forward algorithm;

FIG. 16 is a block diagram of a computer implemented system coupled to an indentation apparatus;

FIG. 17 is a block diagram of an exemplary computer implemented system;

FIG. 18 is a block diagram of the memory system shown in FIG. 16;

FIG. 19 shows experimental and computational indentation responses for two material samples;

FIG. 20 shows simulated equivalent plastic strain (PEEQ) within a 7075-T651 aluminum sample;

FIG. 21 shows comparative results of analyses for a material sample;

FIG. 22 shows comparative results of analyses for another material sample;

FIG. 23 shows comparative results of analyses including an algorithm shown in FIG. 14; and

FIG. 24 shows comparative results of analyses including the algorithm shown in FIG. 14 for another material sample.

### NOMENCLATURE

Aₘₐₓ: contact area of an indenter at maximum load

aₘ: contact radius of an indenter at maximum load

C: loading curvature of indentation response

c* coefficient to account for the shape of pyramidal indenters and large deformation

E: Young's modulus of sample

E*: reduced Young's modulus

h: measured depth of an indenter relative to the surface of a sample (penetration; displacement)

hₘ: measured maximum indentation depth (penetration; displacement)

hᵣ: residual indentation depth after complete unloading

n: uniaxial compression strain hardening exponent of sample

Wₚ: plastic work done by an indenter after a complete loading and unloading

Wₜ: total work done by an indenter after a loading

pₐᵥₑ: Meyer's hardness or average contact pressure at maximum load

P: load applied to sample via an indenter

Pₘ: maximum load applied to sample via an indenter

$${( \frac{ⅆ P}{ⅆ h} )}_{{h}_{m}} :$$

initial unloading slope, at maximum load, of load/depth unloading curve

v: Poisson ratio of sample

σ_{0.033}: uniaxial, compressive, true stress at 3.3% plastic strain

σ_{y}: yield strength in uniaxial compression of sample

### DETAILED DESCRIPTION

According to one aspect of the invention, a method is provided for deriving information on mechanical properties of a material sample by analyzing indentation testing data. In one embodiment, the information is derived from data provided by an indentation test performed on a material. According to another embodiment, information predictive of mechanical deformation behavior of a material is derived by predicting the results of an indentation test on a material having predetermined values for various mechanical properties and then performing one or more actual physical indentation tests and optionally comparing the results to the simulated results.

According to another aspect of the invention, a method is provided for predicting load-depth behavior during loading and unloading cycles of indentation tests. The predicted load-depth behavior may be useful in testing or quality control of materials.

According to another aspect of the invention, mechanical property values may be estimated without calculating or measuring a contact area between an indenter and a sample of material.

According to another aspect of the invention, methods for facilitating the determination of at least one mechanical property of a material comprising providing a computer implemented system and/or software product configured to implement the inventive techniques are disclosed. Facilitation, according to such embodiments can comprise the actual use of such system or software product, for example by an end user, as well as the provision of, or provision of access to, such a system or software product to an end user.

Embodiments of the invention may include a software product which, when executed, directs performance of one or more of the above methods. In other embodiments, a computer implemented system may be used to implement one or more of the above methods or a software product. In still other embodiments, an indentation testing apparatus may include a computer implemented system or a software product to perform one or more of the above methods.

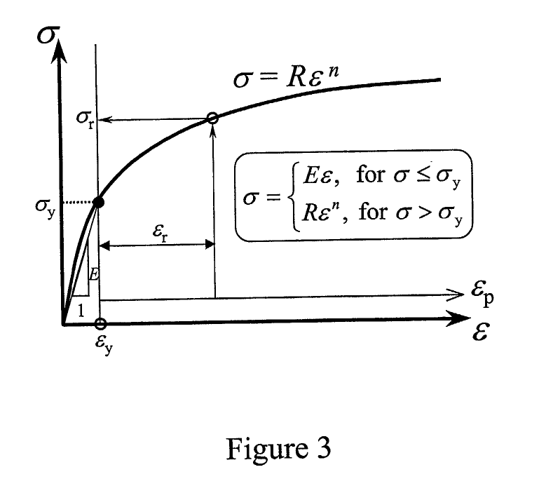

Indentation depth/load relations are typically measured in situ by monitoring the penetration of an indenter into a smooth surface of a specimen over a range of applied loads. The determination of these relations using indenters can enable the determination of well-known fundamental mechanical properties such as Young's modulus (E), representative stress (σᵣ), also referred to as characteristic stress (σ_{char}), yield strength (σ_{y}), and the strain hardening exponent (n). As is known in the art, some of these properties can be obtained from certain aspects of a uniaxial tension or compression stress-strain curve of a sample which can be obtained using standard macro scale tests. A typical stress-strain curve is illustrated in FIG. 3. According to one aspect of the present invention, improved techniques for obtaining such properties by analyzing indentation testing results are provided.

A wide variety of samples such as metals, oxides, carbides, ceramics, glasses, polymers, composites, layered solids such as surface coatings, and similar materials can be measured according to the present invention. Some embodiments of the methodology and apparatus of the invention focus on isotropic, homogenous, elastic and elasto-plastic materials at room temperature. According to one feature, isotropic strain hardening can be determined in elasto-plastic materials.

Embodiments of the present apparatus, systems, and methodology can be used in routine industrial practice in inspection and testing of materials, in some embodiments non-destructively, resulting from metallurgical operations on alloys (e.g., quenching, tempering, nitriding, case-hardening, and annealing) as well as to study variation of chemical composition (e.g., through diffusion). In addition, the techniques, apparatus and systems described herein find use in many research applications.

According to one aspect of the invention, closed-form dimensionless equations comprising functions for relating indentation data and mechanical properties are constructed by deriving dimensionless functional forms and applying computational indentation test simulation results to the functional forms. With the set of closed-form dimensionless equations, estimated load-depth relationships for indentation tests can be constructed based on various mechanical properties without having to perform subsequent finite element analysis or other computational simulations. Additionally, the derived dimensionless equations can allow the estimation of various mechanical properties based on data from an actual indentation test.

One aspect of the invention includes the use of large deformation theory when computationally simulating the indentation response of elasto-plastic solids to derive the above-described closed-form analytical equations. Large deformation theory, also referred to as large strain theory or finite deformation theory, typically incorporates modeling of non-linear geometry effects when calculating the stress-strain response of a material sample. Small deformation theory, used in typical prior art deformation simulations and mechanical property determinations, assumes a negligible change in material configuration under a load. By contrast, large deformation theory accounts for changes in geometrical configuration of a material sample due to the loading which occurs during indentation.

Large deformation theory can therefore provide greater accuracy when simulating the response of a material sample to a contact load between an indenter and the material sample when strains of at least 5% are expected to be present in the contact area of the indenter. Finite element analysis or other computational simulations configured to account for such strains, by utilizing large deformation theory or other methods, can therefore be more accurate at simulating the responses of material samples to indentations. The use of such simulations, according to the invention, can therefore lead to the development of closed-form analytical equations from the simulation data that are better suited to predict mechanical property values from load-depth behavior data or vice versa, as described in greater detail below.

For example, in determining plastic properties such as yield strength (σ_{y}), computational algorithms described herein can, in certain circumstances, estimate values to better than within a factor of about two of the actual yield strength values based on data from an indentation test. In some instances, estimated values for repeated indentation tests can be within about 10% of the actual yield strength value. In some embodiments, the yield strength can be estimated within about 0.1% of the actual value. (See, for example, Example 2 and Tables 5(a) and 5(b) for exemplary comparative results). Systems and methods described below can also provide estimates that are reproducible. The errors mentioned above can be those for an individual test or can be those of an average of several tests. Prior art methods are generally not well suited to determining plastic properties such as yield strength and generally have greater errors than those obtained with the systems and methods provided herein.

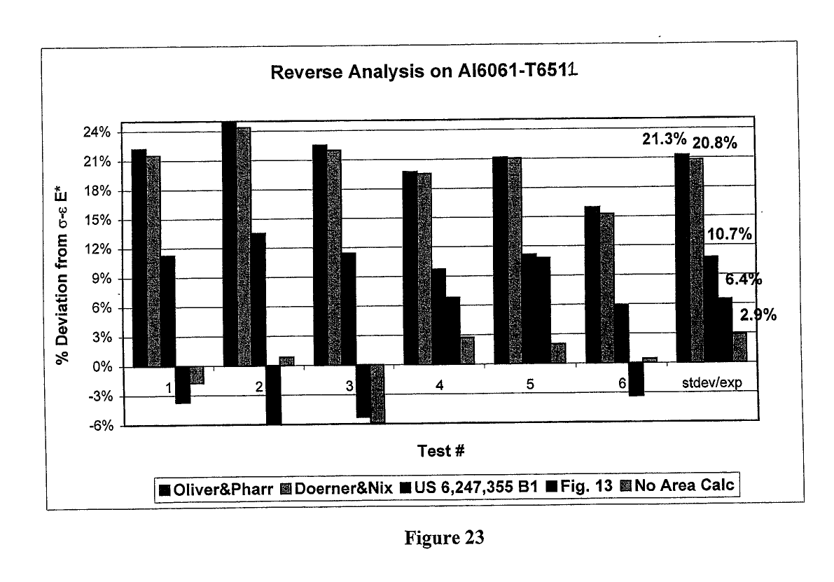

Elastic properties such as reduced Young's modulus (E*) can also be estimated to increased levels of accuracy by systems and methods of certain embodiments of the invention. For example, computational algorithms contained herein can estimate values for reduced Young's modulus to within about 0.5% of the value measured by standard macro scale tests. Analysis of repeated indentation tests of the same material can resulted in estimates having a standard deviation that is less than 7% of the reduced Young's modulus value. In some embodiments and examples, estimates having a standard deviation of less than 3% from the value measured by macro scale tests can be achieved. (See, for example, Example 2, Tables 5(a) and 5(b) and FIG. 23). Estimates having increased accuracy compared to prior art methods can also be provided for other mechanical property values or indentation behavior predictions. For example, loading curvature of indentation response (C), initial unloading slope

$${( \frac{ⅆ {P}_{u}}{ⅆ h} \vert}_{{h}_{m}} ) ,$$

ratio of plastic work to total work, (Wₚ/Wₜ), strain hardening exponent (n), representative stress (σᵣ) and Meyer's hardness (pₐᵥₑ) can also be estimated using systems and methods according to some embodiments of the invention.

According to yet another aspect of the invention, various mechanical properties of a material sample can be estimated without having to measure or calculate a contact area between the indenter and the material surface.

In some embodiments of the invention, a software program is provided to direct performance of the inventive methods on a computer implemented system which can be coupled to an indentation testing apparatus. In one such embodiment, for example, a software program product is provided that directs a system to calculate mechanical properties based on data provided by an indentation test.

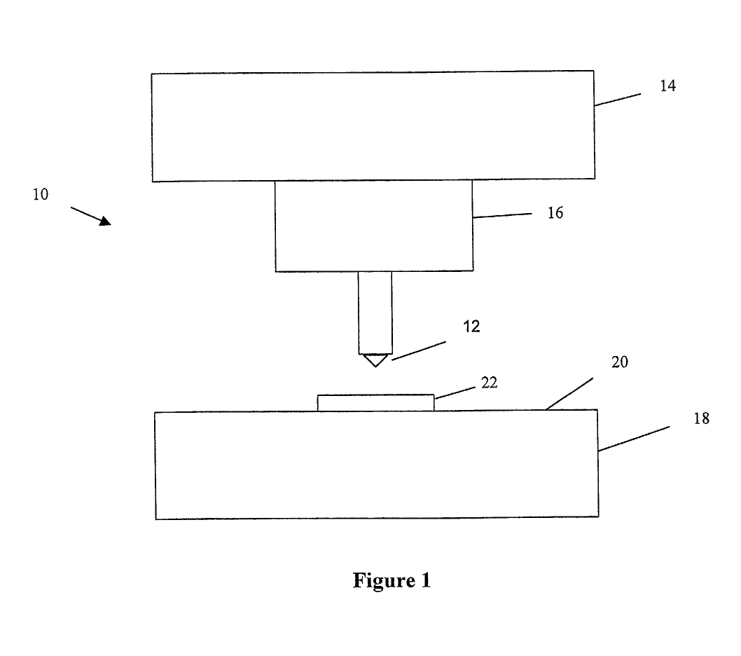

Referring to FIG. 1, a schematic illustration of a typical indentation apparatus 10, which is configured to measure a contact load between an indenter and a sample, is presented. Apparatus 10 includes an upper, indenter-carrying portion and a lower, sample-carrying portion. The upper portion includes an indenter 12 mounted to a top plate 14 and load and displacement transducers 16. The lower portion includes a horizontal positioning base 18 and stage surface 20 upon which a material sample 22 can be mounted. Indenter 12 can move vertically to apply a load to material sample 22, or material sample 22 may be moved vertically on its stage surface 20 toward indenter 12. A controller may induce a load or a displacement between indenter 12 and material sample 22 to perform an indentation test. Load and displacement transducers 16 measure the load (P) present between material sample 22 and indenter 12 and the depth of penetration h of indenter 12 into material sample 22. These values can be transmitted to a computer or data storage medium as signals representing the load and depth of penetration.

A variety of indentation testing instruments can be utilized within the scope of the invention for obtaining indentation load and depth of penetration data, including but not limited to: routine modifications of laboratory load-applying frames; commercially manufactured indenters such as those available from Hysitron (Minneapolis, Minn.), MTS NanoInstruments (Oak Ridge, Tenn.), CSM (Switzerland) or CSIRO (Australia); and modified atomic force microscopes and interfacial force microscopes. Any modifications required to be made to any of the above instruments for use in the context of the techniques of the present invention are well within the skill of one of ordinary skill in the art.

Methods of applying and measuring load and displacement can differ considerably depending on the particular equipment and testing technique employed, but several features are preferable for practicing the current invention, as described below. In one preferred embodiment, the load and depth resolution provided by the equipment are better than about 1% of the maximum load and depth values. The load is preferably applied at a sufficiently low rate to allow “quasistatic” loading conditions to be maintained (e.g., at least approximately 1 minute each for the loading and unloading portions of the test). In many embodiments, the load is applied in an axisymmetric manner via a sharp indenter of specified geometry to the point of maximum load, then reversed fully to the point of complete unloading of the sample. During this cycle, load and depth data can be continuously acquired. The compliance of the machine (i.e., the displacement of the frame itself during indentation) is preferably minimized and quantified and its effects subtracted from the data so that the relative displacement of the indenter into the sample surface can be distinguished from overall machine displacement. Each of the above-mentioned conditions is well understood in the art.

### Mathematical Framework of Indentation Response and Elasto-Plastic Behavior

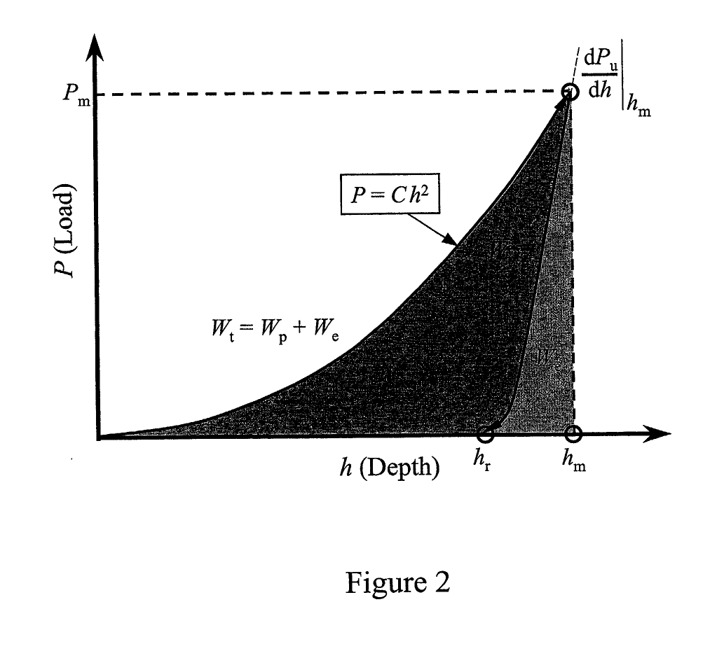

Presented below is a mathematical framework useful for analysis and simulation of indentation test data such as load-depth (P−h) curves. FIG. 2 shows a typical load-depth (P−h) response of an elasto-plastic material to indentation with a sharp indenter. During loading, the response generally follows the relation described by Kick's Law,

P=Ch² (1)

where C is the loading curvature. The average contact pressure,

$${P}_{ave} = \frac{{P}_{m}}{{A}_{m}} ( {A}_{m}$$

is the true projected contact area measured at the maximum load Pₘ), can be identified with the hardness of the indented material. The maximum indentation depth hₘ occurs at Pₘ, and the initial unloading slope is defined as

$${\frac{ⅆ {P}_{u}}{ⅆ h} \vert}_{{h}_{m}} ,$$

where Pᵤ is the unloading force. Wₚ=Wₜ−Wₑ, where the Wₜ term is the total work done by load P during loading, Wₑ is the released (elastic) work during unloading, and Wₚ the stored (plastic) work. The residual indentation depth after complete unloading is hᵣ.

$${C , \frac{ⅆ {P}_{u}}{ⅆ h} \vert}_{{h}_{m}} and \frac{{h}_{r}}{{h}_{m}}$$

are three independent quantities that can be directly obtained from a single P−h curve. Alternately,

$$\frac{{h}_{r}}{{h}_{m}}$$

may be computed by first calculating

$$\frac{{W}_{p}}{{W}_{t}}$$

and then relating

$$\frac{{h}_{r}}{{h}_{m}} to \frac{{W}_{p}}{{W}_{t}} .$$

Plastic behavior of many pure and alloyed engineering metals can be closely approximated by a power law description, as shown schematically in FIG. 3. A simple elasto-plastic, true stress-true strain behavior (i.e. stress and strain calculated using instantaneous cross-sectional area as opposed to initial cross-section area) is modeled as:

$$σ = \{ \begin{matrix}E ϵ , & for σ \leq {σ}_{y} \\ R {ϵ}^{n} , & for σ \geq {σ}_{y}\end{matrix} \qquad ( 2 )$$

where E is the Young's modulus, R is a strength coefficient, n is the strain hardening exponent, σ_{y} is the initial yield stress and ε_{y} is the corresponding yield strain, such that

σ_{y}=Eε_{y}=Rε_{y}ⁿ (3)

Here the yield stress σ_{y} is defined at zero offset strain. The total effective strain, ε, consists of two parts, ε_{y} and εₚ:

ε=ε_{y}+εₚ (4)

where εₚ is the nonlinear part of the total effective strain accumulated beyond ε_{y}. With equations (3) and (4), when σ>σ_{y}, equation (2) becomes

$$σ = {{σ}_{y} ( 1 + \frac{E}{{σ}_{y}} {ϵ}_{p} )}^{n} \qquad ( 5 )$$

To complete the material constitutive description, Poisson's ratio is designated as v, and the incremental theory of plasticity with von Mises effective stress (J₂ flow theory) is assumed.

With the above assumptions and definitions, a material's elasto-plastic behavior is fully determined by the parameters E, v, ε_{y} and n. Alternatively, with the constitutive law defined in equation (2), the power law strain hardening assumption can reduce the mathematical description of plastic properties to two independent parameters. For example, a representative stress σᵣ (defined at εₚ=εᵣ, where εᵣ is a representative strain) and the strain-hardening exponent n may be used to determine a materials' elasto-plastic behavior. Alternately, for example, yield strength σ_{y} and representative stress σᵣ can be used.

### Computational Simulation of Indentation Response

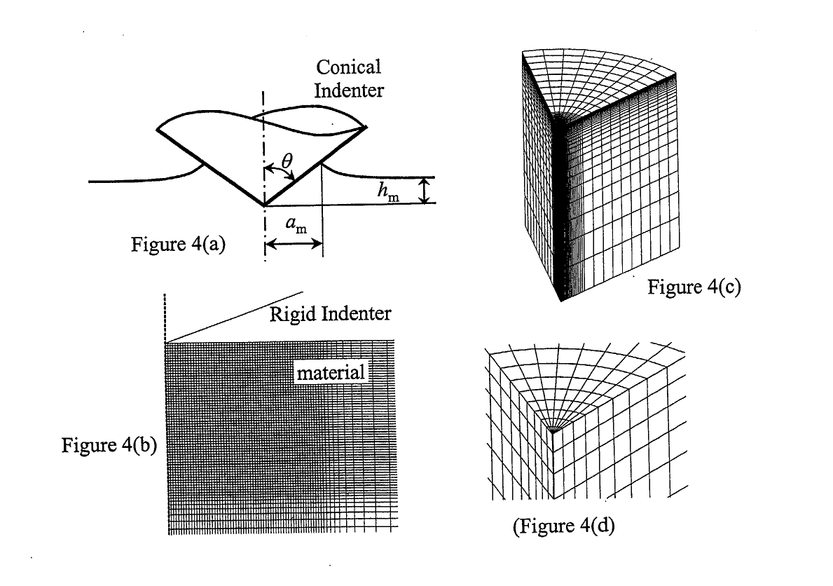

Axisymmetric two-dimensional and full three-dimensional finite element models (FEM) can then be constructed to simulate the indentation response of elasto-plastic solids. These simulations can provide estimated load-depth response data for solids with known material property values. FIG. 4(a) schematically shows a typical sharp conical indenter, where θ is the included half angle of the indenter, hₘ is the maximum indentation depth, and aₘ is the contact radius measured at hₘ. The true projected contact area Aₘ, with pile-up or sink-in effects taken into account, for a conical indenter is thus Aₘ=πaₘ².

FIG. 4(b) shows a typical mesh design employed for axisymmetric calculations. In the present example, the indented solid was modeled as a semi-infinite substrate using 8100 four-noded, bilinear axisymmetric quadrilateral elements, where a fine mesh near the contact region and a gradually coarser mesh further from the contact region were designed to enhance numerical accuracy. At the maximum simulated load, the minimum number of contact elements in the contact zone in the present example was no less than 16 in each FEM computation. The mesh was well-tested for convergence and was determined to be insensitive to far-field boundary conditions.

Of course, in other embodiments the invention is not limited to the finite element model or specific mathematical formulation or arrangement of elements described herein. Additionally, or alternatively, other simulations including computational simulations such as boundary element analysis can be used to model the response of a material sample to indentation testing.

Three-dimensional finite element models incorporating the inherent six-fold or eight-fold symmetry of a Berkovich or a Vickers indenter, respectively, were also constructed. A total of 11,150 and 10,401 eight-noded, isoparametric elements were used for Berkovich and Vickers indentation, respectively. FIG. 4(c) shows an overall mesh design employed for the Berkovich indentation model, while FIG. 4(d) shows in greater detail the area of FIG. 4(c) that directly contacts the indenter tip. Computations were performed using the general purpose finite element package ABAQUS. (ABAQUS Theory Manual Version 6.1, 2000, Pawtucket: Hibbitt, Karlsson and Sorensen, Inc.). The three-dimensional mesh design was verified against the three-dimensional results obtained from the mesh used previously by Larsson et al. Large deformation theory was employed throughout the analysis.

For a conical indenter, the projected contact area is A=πh²tan²θ; for a Berkovich indenter, A=24.56h²; and for a Vickers indenter, A=24.50h². In one embodiment, the three-dimensional indentation induced via Berkovich or Vickers geometries was approximated with axisymmetric two-dimensional models by choosing an apex angle θ such that the projected area/depth of the two-dimensional cone was the same as that for the Berkovich or Vickers indenter. In one example, for both Berkovich and Vickers indenters, the corresponding apex angle θ of the equivalent cone was chosen as 70.3°. Axisymmetric two-dimensional computational results are referenced herein unless otherwise specified. In the finite element computations discussed herein, the indenter was modeled as a rigid body, and the contact was modeled as frictionless. In other embodiments, the indenter and/or contact may be modeled utilizing a different formulation. It was found in the context of the invention that detailed pile-up and sink-in effects were more accurately accounted for by the large deformation theory-based FEM computations employed according to embodiments of the invention, as compared to conventional small deformation theory-based computations.

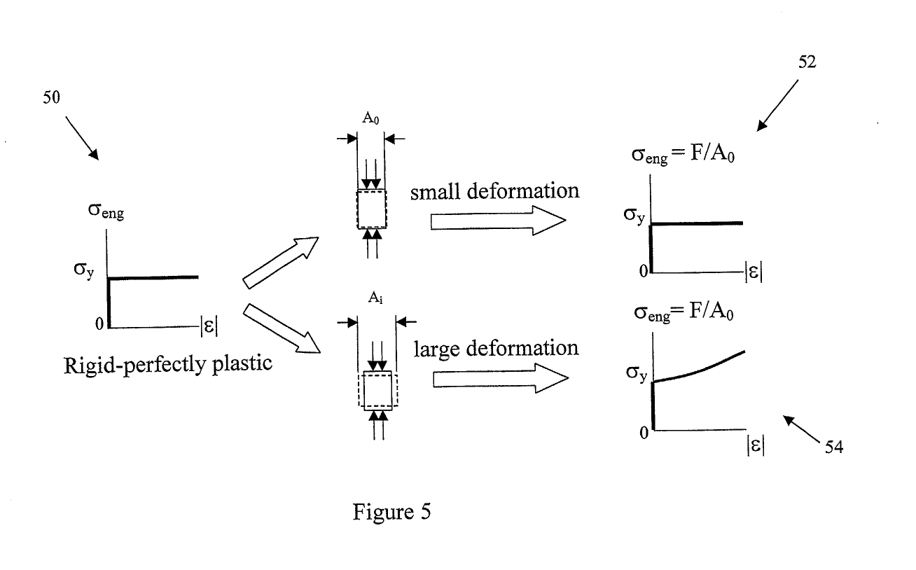

The large deformation theory employed incorporates non-linear deformation modeling, and, when used for simulating the load-depth behavior of a material sample, can more accurately approximate actual load-depth behavior. FIG. 5 illustrates important differences between small deformation theory and large deformation theory based simulations. The example shown in FIG. 5 assumes that the compressive behavior of a material is rigid-perfectly plastic, i.e. there is no strain until the stress reaches the yield strength at which point the material becomes perfectly plastic, as shown in stress-strain curve 50. Because small deformation theory simulation assumes negligible change in material configuration during compression, the cross-sectional area after deformation remains as the initial area A₀. Given that the material is rigid-perfectly plastic, the engineering stress-strain response 52 under small deformation theory shows no strain hardening. In contrast, because large deformation theory assumes considerable change in material configuration, the cross-sectional area of contact after deformation is modeled as Aᵢ, the instantaneous area, which is larger than A₀. To deform a rigid-perfectly plastic material having a larger contact area, a higher load is required. Therefore, the engineering stress-strain response 54 under large deformation theory is stiffer than the small deformation response.

In some embodiments, as a result of utilizing the above described computational simulation methodology provided according to the invention, when employing closed-form analytical equations based on the simulations, strains of at least about 5% in the material can accounted for in determining or estimating the load-depth behavior of a material during an indentation test. In other embodiments, strains of at least about 10%, 15%, 20%, 30%, 40%, 50%, 60% or 75% can be accounted for. In some embodiments, the strains can be accounted for by utilizing large deformation theory and performing computation simulations of load-depth behavior. Closed-form functions which relate mechanical property values and load-depth behavior can then be developed by using the simulation results.

### Dimensionless Functions

A number of new, closed-form universal dimensionless functions are provided according to one aspect of the invention for the purpose of relating indentation test data and mechanical property values. The functions are developed using dimensional analysis and large deformation theory based simulation results similar to those described above. Once developed, the functions may be used to relate load-depth behavior to mechanical properties or vice versa without the need to perform any computational simulation (e.g., finite element simulation).

As discussed above, one can use a material parameter set (E, v, σ_{y} and n), (E, v, σᵣ and n) or (E, v, σ_{y} and σᵣ) to describe constitutive behavior of a material response to applied load. Therefore, the specific functional forms of the universal dimensionless functions given below are not unique but depend on the particular material parameter set used as a basis to formulate the functions. For instrumented sharp indentation, a particular material constitutive description yields its own distinct set of dimensionless functional forms. For example, an assumption of power law strain hardening yields a distinct set of dimensionless functions. One may choose to use essentially any plastic strain to be the representative strain εᵣ, where the corresponding representative stress σᵣ is used to describe the dimensionless functions. However, it may be preferable to use the representative strain that best normalizes a particular dimensionless function with respect to strain hardening.

In the below-described embodiment of the present invention, one particular, exemplary set of universal dimensionless functional forms provided according to the invention is specifically derived. Additionally, a closed-form relationship between indentation data and elasto-plastic properties is provided by deriving best-fit equations based on the computational simulations described above. This set of functions is used to develop new algorithms for accurately predicting the load-depth (P−h) response from known elasto-plastic properties (referred to herein as forward algorithms) and new algorithms for systematically estimating an indented material's elasto-plastic properties from the P−h data of a single indentation test (referred to herein as reverse algorithms).

Dimensional analysis was used to reduce the number of independent variables in the universal functions by grouping terms such that their units cancel each other out.

### Dimensionless Function π₁

For a sharp indenter (conical, Berkovich or Vickers, with fixed indenter shape and tip angle) indenting normally into a power law elasto-plastic solid, the load P can be written as

P=P(h, E, v, Eᵢ, vᵢ, σ_{y}, n), (6)

where Eᵢ is Young's modulus of the indenter, and vᵢ is the indenter's Poisson's ratio. This functionality can be simplified (e.g., Johnson, K. L., 1985, Contact Mechanics, Cambridge University Press, London) by combining elasticity effects of an elastic indenter and an elasto-plastic solid as

P=P(h, E*, σ_{y}, n), (7)

where

$${E}^{*} = {( [ \frac{1 - {v}^{2}}{E} + \frac{1 - {v}_{i}^{2}}{{E}_{i}} ] )}^{- 1} \qquad ( 8 )$$

Alternatively, equation (7) can be written as

P=P(h, E*, σᵣ, n) (9)

or

P=P(h, E*, σ_{y}, σᵣ) (10)

Applying the π theorem in dimensional analysis (Barenblatt, G. I., Scaling, Self-Similarity and Intermediate Asymptotics, Cambridge University Press, 1994), equation (9) becomes

$$\begin{matrix}P = {σ}_{r} {h}^{2} {Π}_{1} ( \frac{{E}^{*}}{{σ}_{r}} , n ) , \\ and thus & ( \text{11a} ) \\ C = \frac{P}{{h}^{2}} = {σ}_{r} {Π}_{1} ( \frac{{E}^{*}}{{σ}_{r}} , n ) . & ( \text{11b} )\end{matrix}$$

where π₁ is a dimensionless function. Similarly, applying the π theorem to equation (10), loading curvature C may alternatively be expressed as

$$\begin{matrix}C = \frac{P}{{h}^{2}} = {σ}_{y} {Π}_{1}^{A} ( \frac{{E}^{*}}{{σ}_{y}} , \frac{{σ}_{r}}{{σ}_{y}} ) \\ o r & ( \text{12a} ) \\ C = \frac{P}{{h}^{2}} = {σ}_{r} {Π}_{1}^{B} ( \frac{{E}^{*}}{{σ}_{r}} , \frac{{σ}_{y}}{{σ}_{r}} ) & ( \text{12b} )\end{matrix}$$

where π₁^{A} and π₁^{B} are dimensionless functions.

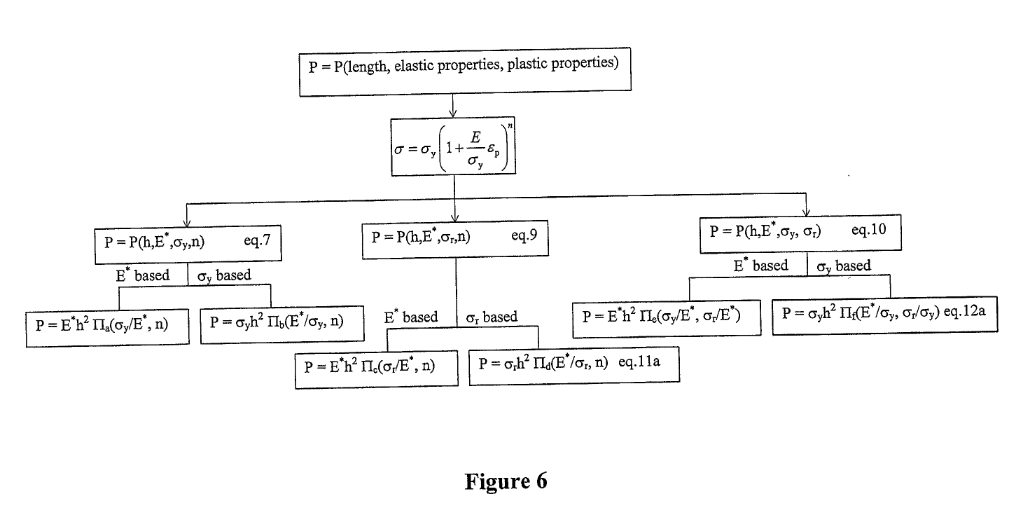

During nanoindentation experiments, especially when the indentation depth is between about 100 to 1000 nm, size-scale-dependent indentation effects have been postulated. (e.g., see Gerberich, W. W., Nelson, J. C., Lilleodden, E. T., Anderson, P., and Wyrobek, J. T., 1996, Acta mater., 44, 3585; Fleck, N. A., and Hutchinson, J. W., 1993, J. Mech. Phys. Solids, 41, 1825, hereinafter Fleck; Gao, H., Huang, Y., Nix, W. D., and Hutchinson, J. W., 1999, J. Mech. Phys. Solids, 47, 1239, hereinafter Gao). These possible size-scale-dependent effects on hardness have been modeled using higher order theories. (e.g., Fleck, Gao). If the indentation is sufficiently deep (typically deeper than 1 μm), then the scale dependent effects become small and may be ignored. For the current algorithms, any scale dependent effects have been assumed to be insignificant. In other embodiments, such effects can be accounted for in the development of the algorithms. Equations (11) and (12) tend to indicate that the equation P=Ch² is the natural outcome of the dimensional analysis for a sharp indenter, and that it is essentially independent of the specific constitutive behavior; loading curvature C is a material constant which is independent of indentation depth. It is also noted that, depending on the choices of (εᵣ, σᵣ), there can be an essentially infinite number of ways to define the dimensionless function π₁ However, with the assumption of power-law strain hardening, it can be readily shown that one definition of π₁ is easily converted to another definition, and therefore all such definitions are within the scope of the present invention. For example, FIG. 6 shows a tree of alternatives for constructing a dimensionless function that relates load to four parameters (depth, Young's modulus, yield strength, and the strain hardening exponent).

### Dimensionless Function π₂

If the unloading force is represented as Pᵤ, the unloading slope is given by

$$\frac{ⅆ {P}_{u}}{ⅆ h} = \frac{ⅆ {P}_{u}}{ⅆ h} ( h , {h}_{m} , E , v , {E}_{i} , {v}_{i} , {σ}_{r} , n ) \qquad ( \text{13a} )$$

or, for elasticity effects characterized by E*, the unloading slope is given by

$$\frac{ⅆ {P}_{u}}{ⅆ h} = \frac{ⅆ {P}_{u}}{ⅆ h} ( h , {h}_{m} , {E}^{*} , {σ}_{r} , n ) \qquad ( \text{13b} )$$

Dimensional analysis yields

$$\frac{ⅆ {P}_{u}}{ⅆ h} = {E}^{*} h {Π}_{2}^{0} ( \frac{{h}_{m}}{h} , \frac{{σ}_{r}}{{E}^{*}} , n ) \qquad ( 14 )$$

Evaluating equation (14) at h=hₘ gives

$$\frac{ⅆ {P}_{u}}{ⅆ h} {\vert}_{h = {h}_{m}} = {E}^{*} {h }_{m} {Π}_{2}^{0} ( 1 , \frac{{σ}_{r}}{{E}^{*}} , n ) = {E}^{*} {h }_{m} {Π}_{2} ( \frac{{E}^{*}}{{σ}_{r}} , n ) \qquad ( 15 )$$

### Dimensionless Function π₃

Similarly, Pᵤ itself can be expressed as

$${P}_{u} = {P}_{u} ( h , {h}_{m} , {E}^{*} , {σ}_{r} , n ) = {E}^{*} {h}^{2} {Π}_{u} ( \frac{{h}_{m}}{h} , \frac{{σ}_{r}}{{E}^{*}} , n ) \qquad ( 16 )$$

When Pᵤ=0, the specimen is fully unloaded and, thus, h=hᵣ. Therefore, upon complete unloading,

$$0 = {Π}_{u} ( \frac{{h}_{m}}{{h}_{r}} , \frac{{σ}_{r}}{{E}^{*}} , n ) \qquad ( 17 )$$

Rearranging equation (17),

$$\frac{{h}_{r}}{{h}_{m}} = {Π}_{3} ( \frac{{σ}_{r}}{{E}^{*}} , n ) \qquad ( 18 )$$

Thus, three universal dimensionless functions, π₁, π₂ and π₃, may be used to relate mechanical properties to a measured or simulated indentation response.

### Closed-Form Equations—Development of Computational Model Algorithms

According to one aspect of the invention, the above developed dimensionless functions are mathematically or numerically fit to the computational simulation results for various parameter values using, for example, a commercially available curve-fitting program. The resulting closed-form equations can relate mechanical property values and indentation test data across broadly applicable parameter ranges without requiring any further computational simulation (e.g. FEM simulation). In this regard, the closed-form equations can serve to lessen computer run-time needed to estimate mechanical property values or to predict the load-depth of an indentation test. In other embodiments, the dimensionless functions can be fit to physical indentation test results instead of computational simulation results.

In one exemplary embodiment, in order to develop a set of closed-form equations with broad applicability, large deformation finite element computational simulations of depth-sensing indentation (described above) were carried out for 76 different combinations of elasto-plastic properties that encompass a wide range of parameter values commonly found in pure and alloyed engineering metals. Such materials may fall within a range of parameter values that is poorly modeled by computational small deformation theory. Young's modulus, E, was varied from 10 to 210 GPa, yield strength, σ_{y}, was varied from 30 to 3000 MPa, and strain hardening exponent, n, was varied from 0 to 0.5. The Poisson's ratio, v, was fixed at 0.3. Table 1 tabulates the elasto-plastic parameters used in these 76 cases.

TABLE 1
Elasto-plastic Parameters Used

| | E (GPa) | σ_{y} (Mpa) | σ_{y}/E |
|---|---|---|---|
| 19 combinations | 10 | 30 | 0.003 |
| of E and σ_{y}⁵¹⁷ | 10 | 100 | 0.01 |
| | 10 | 300 | 0.03 |
| | 50 | 200 | 0.004 |
| | 50 | 600 | 0.012 |
| | 50 | 1000 | 0.02 |
| | 50 | 2000 | 0.04 |
| | 90 | 500 | 0.005556 |
| | 90 | 1500 | 0.016667 |
| | 90 | 3000 | 0.033333 |
| | 130 | 1000 | 0.007692 |
| | 130 | 2000 | 0.015385 |
| | 130 | 3000 | 0.023077 |
| | 170 | 300 | 0.001765 |
| | 170 | 1500 | 0.008824 |
| | 170 | 3000 | 0.017647 |
| | 210 | 300 | 0.001429 |
| | 210 | 1800 | 0.008571 |
| | 210 | 3000 | 0.014286 |

^{§}For each one of the 19 cases listed above, strain-hardening exponent n is varied from 0, 0.1, 0.3 to 0.5, resulting a total of 76 different cases.

The first dimensionless function of interest is π₁. From equation (11b),

$${Π}_{1} ( \frac{{E}^{*}}{{σ}_{T}} , n ) = \frac{C}{{σ}_{r}} \qquad ( 19 )$$

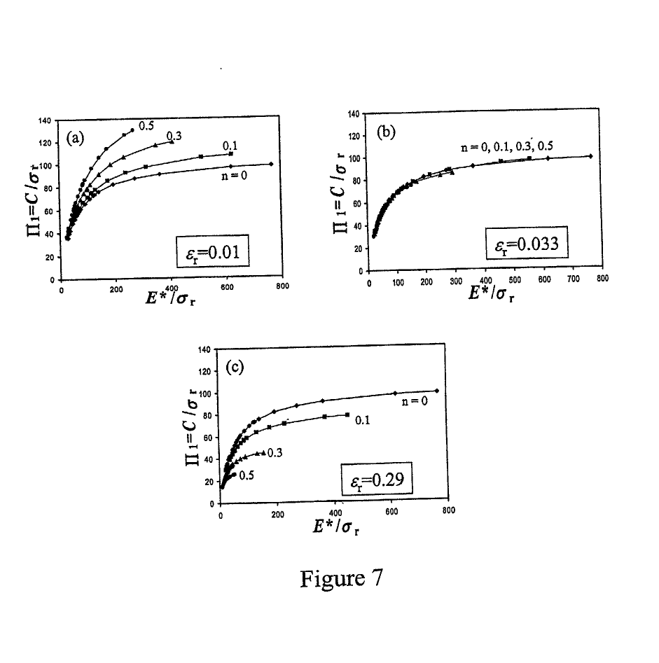

The specific functional form of π₁ may vary, depending on the choice of εᵣ and σᵣ. FIG. 7 shows the computationally obtained results using three different values of εᵣ (i.e., εₚ=0.01, 0.033 and 0.29) and the corresponding σᵣ. The results in FIG. 7 indicate that, for the present example, for εᵣ<0.033, π₁ increased with increasing n; for εᵣ>0.033, π₁ decreased with increasing n. Minimizing the relative errors using a least squares algorithm, a polynomial function

$${Π}_{1} ( \frac{{E}^{*}}{{σ}_{0.033}} ) = \frac{C}{{σ}_{0.033}}$$

fit all 76 data points within a ±2.85% error when εᵣ=0.033. For this set of computationally derived results, the best-fit π₁ function is:

$${Π}_{1} = \frac{C}{{σ}_{0.033}} = - {1.131 [ ln ( \frac{{E}^{*}}{{σ}_{0.033}} ) ]}^{3} + {13.635 [ ln ( \frac{{E}^{*}}{{σ}_{0.033}} ) ]}^{2} - 30.594 [ ln ( \frac{{E}^{*}}{{σ}_{0.033}} ) ] + 29.267 \qquad ( 20 )$$

The dimensionless function π₁ normalized with respect to σ_{0.033} was found to be independent of strain hardening exponent n. This result indicates that, for a given value of E*, essentially all power law plastic, true stress-true strain responses that exhibit the same true stress at 3.3% true plastic strain give the same indentation loading curvature C. It is noted that this result was obtained within the specified range of material parameters using the material constitutive behavior defined by equation (2).

The expression ln

$$ln ( \frac{{E}^{*}}{{σ}_{r}} )$$

was chosen as a base for the polynomial expression in functions π₁, π₂, and π₃. This expression was used to achieve the best fitting results with polynomial terms. Similar treatment was used in a spherical cavity model. (Hill, R., The Mathematical Theory of Plasticity, Clarendon Press, Oxford, 1950, p. 104).

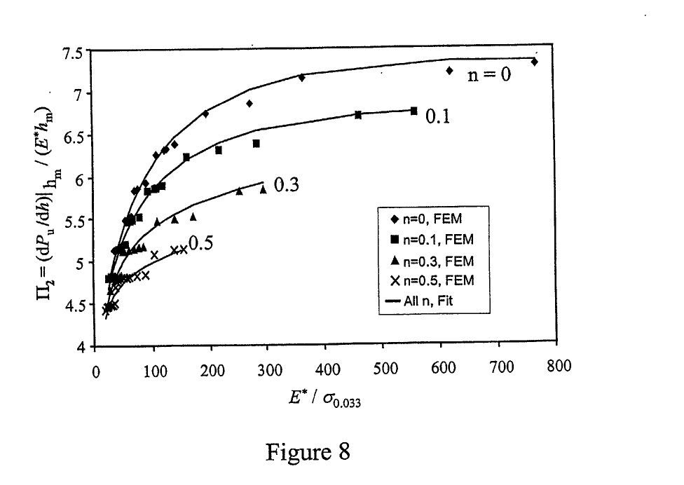

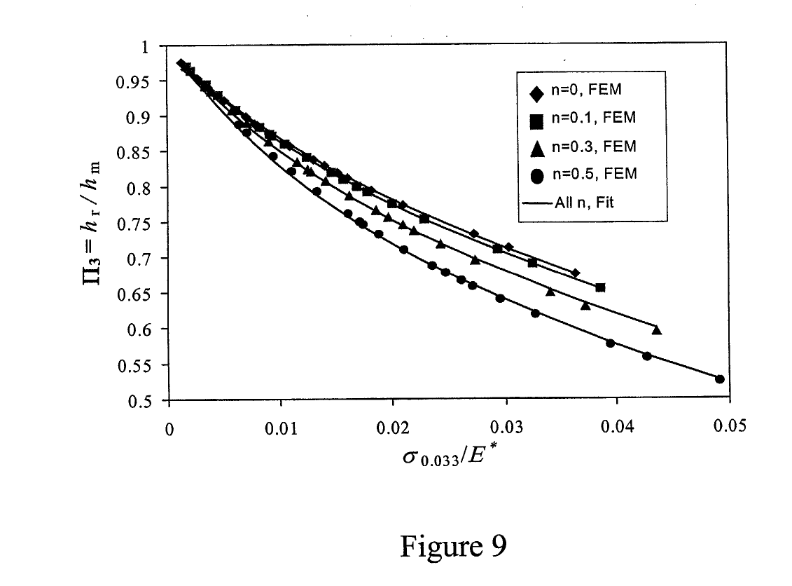

FIG. 8 shows the dimensionless functions π₂ and FIG. 9 shows the dimensionless function π₃. Within a ±2.5% and a ±0.77% error,

$${Π}_{2} ( \frac{{E}^{*}}{{σ}_{r}} , n ) = \frac{1}{{E}^{*} {h}_{m}} \frac{ⅆ {P}_{u}}{ⅆ h} {\vert}_{{h}_{m}}$$

and

$${Π}_{3} ( \frac{{σ}_{r}}{{E}^{*}} , n ) = \frac{{h}_{r}}{{h}_{m}}$$

fit all 76 sets of FEM computed data shown in FIGS. 8 and 9, respectively. For this set of computationally derived results, the best-fit π₂ equation is:

$${Π}_{2} ( \frac{{E}^{*}}{{σ}_{r}} , n ) = \frac{1}{{E}^{*} {h}_{m}} \frac{ⅆ {P}_{u}}{ⅆ h} {\vert}_{{h}_{m}} = {( - 1.40557 {n}^{3} + 0.77526 {n}^{2} + 0.15830 n - 0.06831 ) [ ln ( \frac{{E}^{*}}{{σ}_{0.033}} ) ]}^{3} + {( 17.93006 {n}^{3} - 9.22091 {n}^{2} - 2.37733 n + 0.86295 ) [ ln ( \frac{{E}^{*}}{{σ}_{0.033}} ) ]}^{2} + ( - 79.99715 {n}^{3} + 40.55620 {n}^{2} + 9.00157 n - 2.54543 ) [ ln ( \frac{{E}^{*}}{{σ}_{0.033}} ) ] + ( 122.65069 {n}^{3} - 63.88418 {n}^{2} - 9.58936 n + 6.20045 ) \qquad ( 21 )$$

Also based on this set of computationally derived results, the best-fit π₃ function is:

$${Π}_{3} ( \frac{{σ}_{r}}{{E}^{*}} , n ) = \frac{{h}_{r}}{{h}_{m}} = {( 0.010100 {n}^{2} + 0.0017639 n - 0.0040837 ) [ ln ( \frac{{σ}_{0.033}}{{E}^{*}} ) ]}^{3} + {( 0.14386 {n}^{2} + 0.018153 n - 0.088198 ) [ ln ( \frac{{σ}_{0.033}}{{E}^{*}} ) ]}^{2} + ( 0.59505 {n}^{2} + 0.034074 n - 0.65417 ) [ ln ( \frac{{σ}_{0.033}}{{E}^{*}} ) ] + ( 0.58180 {n}^{2} - 0.088460 n - 0.67290 ) \qquad ( 22 )$$

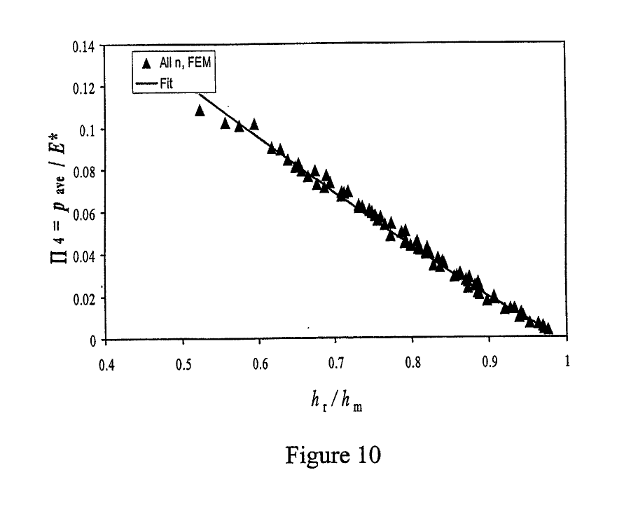

Several other approximate dimensionless functions can also be computationally derived. For example, FIG. 10 shows a dimensionless function

$${Π}_{4} ( \frac{{h}_{r}}{{h}_{m}} ) = \frac{{p}_{ave}}{{E}^{*}}$$

which is within ±13.85% of the computationally obtained values for the above-mentioned 76 cases:

$${Π}_{4} = \frac{{p}_{ave}}{{E}^{*}} \approx 0.268536 {( 0.9952495 - \frac{{h}_{r}}{{h}_{m}} )}^{1.1142735} \qquad ( 23 )$$

It is noted that the verified range for π₄ is

$$0.5 < \frac{{h}_{r}}{{h}_{m}} < 0.98 .$$

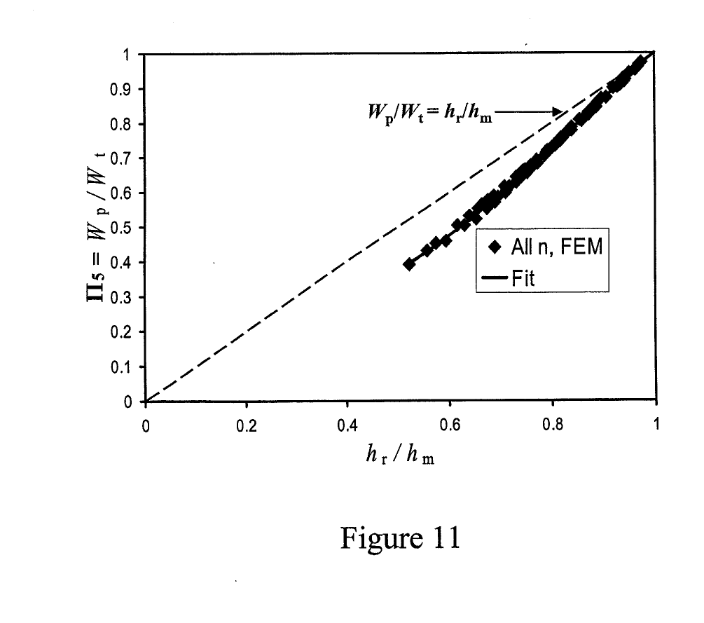

FIG. 11 shows dimensionless function

$${Π}_{5} ( \frac{{h}_{r}}{{h}_{m}} ) = \frac{{W}_{p}}{{W}_{t}}$$

which is within ±2.38% of the numerically computed values for the 76 cases. With these computed values, the best-fit function π₅ is:

$${Π}_{5} = \frac{{W}_{p}}{{W}_{t}} = 1.61217 \{ 1.13111 - {1.74756}^{ [ - 1.49291 {( \frac{{h}_{r}}{{h}_{m}} )}^{2.535334} ]} - 0.075187 {( \frac{{h}_{r}}{{h}_{m}} )}^{1.135826} \} \qquad ( 24 )$$

The verified range for function π₅ is the same as that for π₄, i.e.

$$0.5 < \frac{{h}_{r}}{{h}_{m}} < 0.98 .$$

FIG. 11 shows that

$$\frac{{W}_{p}}{{W}_{t}} = \frac{{h}_{r}}{{h}_{m}}$$

is not a good approximation except when

$$\frac{{h}_{r}}{{h}_{m}}$$

approaches unity.

A sixth dimensionless function was constructed based on equation (25) below. (King, R. B., 1987, Int. J. Solids Structures, 23, 1657).

$${E}^{*} = \frac{1}{{c}^{*} \sqrt{{A}_{m}}} \frac{ⅆ {P}_{u}}{ⅆ h} {\vert}_{{h}_{m}} \qquad ( 25 )$$

where conventional small deformation based linear elastic analysis gives c*=1.167 for a Berkovich indenter, 1.142 for a Vickers indenter and 1.128 for a conical indenter. Large deformation elasto-plastic analysis of the 76 cases showed that c*≈1.1957 (within ±0.9% error) for a conical indenter with θ=70.3°. This value of c*, which takes into account the elasto-plastic finite deformation prior to the unloading, is about 6% higher than that for small-deformation based, linear-elastic solution (i.e., 1.128). Assuming the same comparative difference between the large deformation elasto-plastic solution and the elastic solution for the Berkovich and Vickers geometries, the large deformation theory-adjusted values of c* would be 1.2370 and 1.2105, respectively. This completes another important dimensionless function π₆,

$${Π}_{6} = \frac{1}{{E}^{*} \sqrt{{A}_{m}}} \frac{ⅆ {P}_{u}}{ⅆ h} {\vert}_{{h}_{m}} = {c}^{*} \qquad ( 26 )$$

For a conical indenter with θ=70.3°, noting that Aₘ=πaₘ², equation (26) can be rewritten as

$${Π}_{6 C} = \frac{1}{{E}^{*} {a}_{m}} \frac{ⅆ {P}_{u}}{ⅆ h} {\vert}_{{h}_{m}} = {c}^{*} \sqrt{π} \approx 2.12 \qquad ( 27 )$$

Note that equation (27) is simply a revision of (25) in light of the computationally derived values of c*. In the prior art (e.g., Oliver and Pharr), c*\sqrt{π}=2 was used (i.e., with c*=1.128, the linear elastic solution). Table 2 shows the values of c* used in the method provided according to the invention and prior art derived values.

TABLE 2
Derived values of c*

| | Small deformation | |
|---|---|---|
| | Linear elastic solution | Large deformation |
| c* | (King) | elasto-plastic solution |
| Conical | 1.128 | 1.1957 |
| Berkovich | 1.167 | 1.2370 |
| Vickers | 1.142 | 1.2105 |

It is noted that π₃ and π₄ are interdependent, i.e., function π₄ together with dimensionless functions π₁, π₂ and π₆, can be used to solve for π₃. Alternative universal dimensionless functions, which can be fit to the indentation tests or simulations may also be utilized in other embodiments of the invention.

Function π₅ relates

$$\frac{{W}_{p}}{{W}_{t}} t o \frac{{h}_{r}}{{h}_{m}} .$$

The quantity

$$\frac{{h}_{r}}{{h}_{m}}$$

can be difficult to obtain experimentally due to the inherent instability of complete unloading to a residual depth hᵣ. Therefore,

$$\frac{{W}_{p}}{{W}_{t}}$$

can instead be measured and π₅, can be used to obtain a value for

$$\frac{{h}_{r}}{{h}_{m}}$$

from

$$\frac{{W}_{p}}{{W}_{t}} .$$

### Alternative Set of Universal Dimensionless Equations Which Eliminates Need to Calculate Contact Area

An alternative set of universal dimensionless equations are developed in this section. Using three of the universal dimensionless functions described above (π₁, π₂, and π₃), values for various mechanical properties can be calculated with a set of closed-form equations which does not require the calculation of contact area Aₘₐₓ. The derivation of these equations is shown below.

From above, π₁, π₂, and π₃ are as follows:

$$\begin{matrix}{Π}_{1} ( \frac{{E}^{*}}{{σ}_{0.033}} ) = \frac{C}{{σ}_{0.033}} & ( 28 ) \\ {Π}_{2} ( \frac{{E}^{*}}{{σ}_{0.033}} , n ) = \frac{1}{{E}^{*} {h}_{m}} \frac{ⅆ {P}_{u}}{ⅆ h} {\vert}_{h m} & ( 29 ) \\ {Π}_{3} ( \frac{{σ}_{0.033}}{{E}^{*}} , n ) = \frac{{h}_{r}}{{h}_{m}} & ( 30 )\end{matrix}$$

Combining equations (28) and (29) yields:

$${f}_{1} ( {r}_{E} , n ) = {r}_{E} {Π}_{2} ( {r}_{E} , n ) - \frac{1}{C {h}_{m}} \frac{ⅆ {P}_{u}}{ⅆ h} {\vert}_{h m} {Π}_{1} ( {r}_{E} ) = 0 \qquad ( 31 )$$

where

$${r}_{E} = \frac{{E}^{*}}{{σ}_{0.033}} .$$

Rewriting equation (30) to be:

$${Π}_{3}^{n e w} ( \frac{{E}^{*}}{{σ}_{0.033}} , n ) = {Π}_{3} ( \frac{1}{( {E}^{*} / {σ}_{0.033} )} , n ) = \frac{{h}_{r}}{{h}_{m}} \qquad ( 32 )$$

From equation (32), equation (33) can be constructed as below:

$${f}_{2} ( {r}_{E} , n ) = {Π}_{3}^{n e w} ( {r}_{E} , n ) - \frac{{h}_{r}}{{h}_{m}} = 0 \qquad ( 33 )$$

Using the two equations (31) and (33), the two unknowns r_{E} and n can be readily solved numerically. Once r_{E} is known, σ0.033 can be obtained from equation (28):

$$\begin{matrix}{σ}_{0.033} = \frac{C}{{Π}_{1} ( {r}_{E} )} \\ F i n a l l y , & ( 34 ) \\ {E}^{*} = {r}_{E} {σ}_{0.033} & ( 35 )\end{matrix}$$

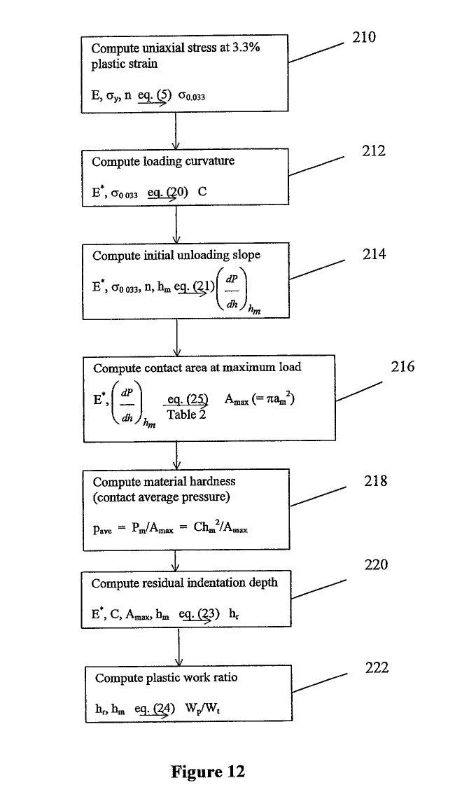

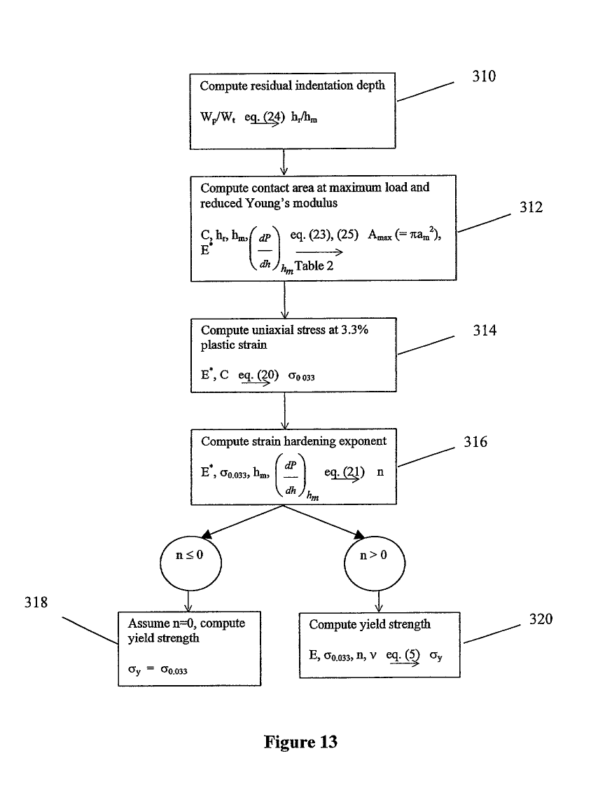

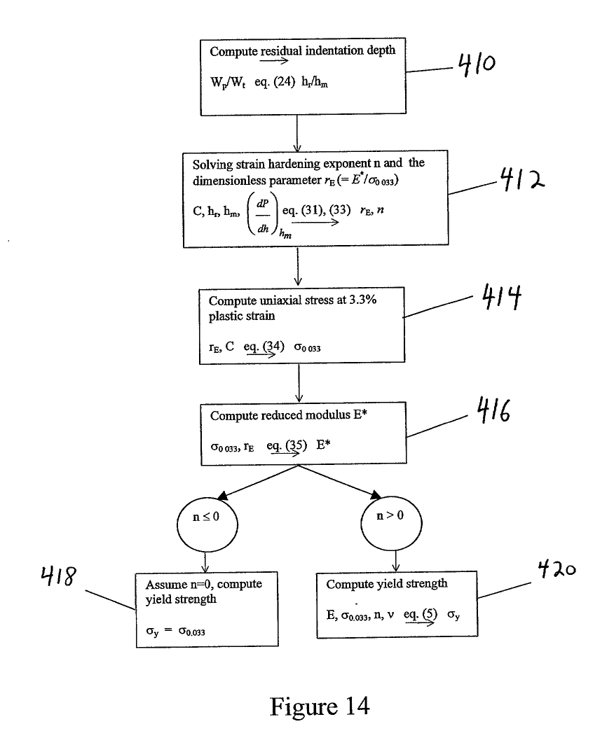

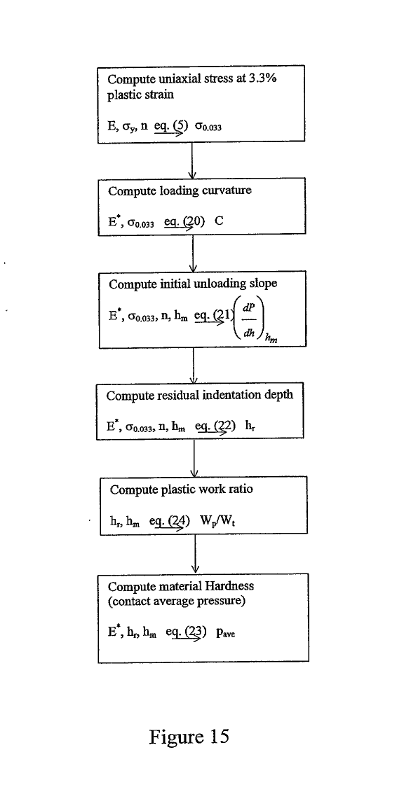

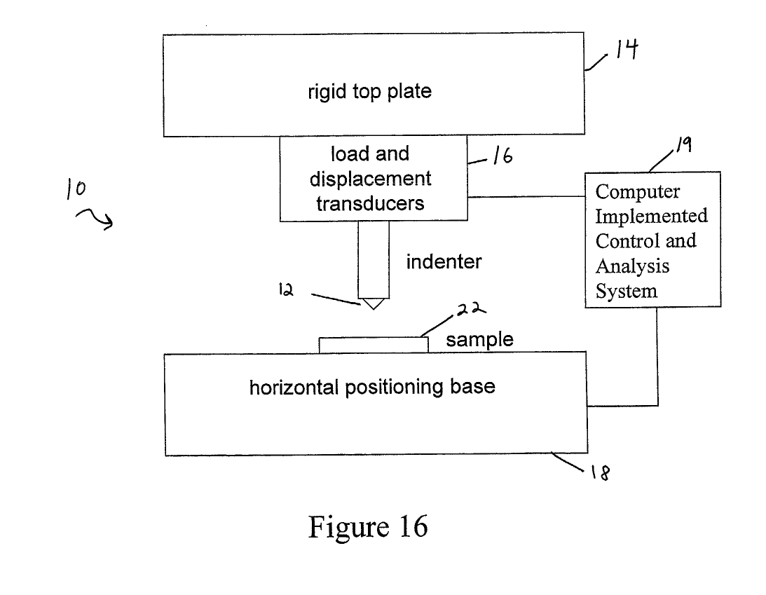

The flow chart in FIG. 14 shows one method of incorporating these equations into an algorithm for estimating values of elasto-plastic properties from indentation test data without computing or measuring the contact area between an indenter and a material sample. A more thorough description of the calculation algorithm of the flow chart is given below after the description of the algorithms of FIGS. 12 and 13. The flow chart in FIG. 15 shows one method of incorporating these equations into an algorithm for predicting a depth-load response behavior in an indentation test based on mechanical property values without computing or measuring the contact area.

### Computational Algorithms for Predicting Indentation Behavior from Mechanical Properties and Estimating Mechanical Property Values from Indentation Testing Data

The above closed-form functions developed from dimensional analysis and computational simulations can be applied to a methodology for predicting load-depth behavior for an indentation test based on mechanical property values. In another embodiment, the above functions can be used to analyze indentation test data to estimate mechanical property values. Example algorithms are presented and discussed below.

### Predicting Indentation Behavior from Mechanical Property Values (Forward Algorithm)

According to one embodiment, using a representative set of closed-form functions, which were developed as discussed above, values for various parameters of a load/depth response curve can be estimated based on values of mechanical properties by using an algorithm such as the one described in FIG. 12. In step 210, with equation (5), a representative stress (e.g., uniaxial stress at 3.3%) can be calculated from specified values E, σ_{y} and n. In step 212, with a representative stress at 3.3% plastic strain from equation (5) and a specified reduced Young's modulus E*, the loading curvature C is given according to equation (20). In step 214, using E*, σ_{0.033}, n and hₘ, the value of dP/dh at hₘ can be obtained in step 214 according to equation (21). In step 216 the contact area at maximum load can then be calculated at maximum load using equation (25) with values for E* and

$$\frac{ⅆ {P}_{u}}{ⅆ h} {\vert}_{{h}_{m}} .$$

The contact average pressure can then be calculated (step 218). In step 220, the residual indentation depth hᵣ can be calculated with equation (23) and in step 222 the plastic work ration (Wₚ/Wₜ) can be calculated using equation (24).

The algorithm described in FIG. 12 was applied to mechanical property values in Example 2. The results were compared to experimental indentation data and it can be seen from these results that the example algorithm of FIG. 12 predicted values of C to within a few percent.

The particular sequence of equations shown above is not absolutely required to calculate all estimated values for the parameters of an estimated load/depth curve. In other embodiments, other sequences or other equations can be used to calculate the parameters. In some embodiments, one of which is described later, an algorithm is employed in which the contact area of indentation need not be calculated.

### Estimating Mechanical Property Values from Indentation Testing Data (Reverse Algorithm)

The closed-form functions developed above can also be applied to a reverse algorithm for estimating the values of mechanical properties of a material tested using an indenter apparatus.

An estimate of mechanical property values based on an analysis of load/depth data from an indentation test performed using a sharp indenter will now be described in connection with FIG. 13. After measuring or receiving indentation test data, hᵣ/hₘ is computed in step 310 in accordance with equation (24). Next, the contact area at maximum load Aₘₐₓ and the combined Young's modulus E* are computed in step 312 according to equations (23) and (25). The representative stress σᵣ is then computed in step 314 according to equation (20). Strain hardening exponent n is then computed using equation (21) in step 316. If strain hardening exponent n is less than or equal to zero, it is taken as zero and in step 318 the yield strength σ_{y} is estimated to be equal to the representative stress calculated in step 314. If strain hardening exponent n is greater than zero, the yield strength σ_{y} is computed in step 320 with equation (5).

Alternatively, due to the interdependence between π₃ (equation 22) and π₄ (equation 23), the dimensionless function π₃ can be used instead of π₄ within the reverse algorithm to calculate properties.

### Reverse Algorithm Without Calculating Contact Area

An alternative algorithm for estimating mechanical property values from indentation data is described in FIG. 14. This representative algorithm can provide values for reduced Young's modulus, representative stress, yield strength, and the strain hardening exponent by employing closed-form functions developed above.

An example flow chart for estimating mechanical property values from indentation test data without calculating or measuring contact area between the indenter and the material tested is shown in FIG. 14. In step 410, after determining

$$\frac{{W}_{p}}{{W}_{t}} , \frac{{h}_{r}}{{h}_{m}}$$

is calculated using equation (24). In step 412, strain hardening exponent n and a dimensionless parameter r_{E} (equal to E*/σ_{0.033}) are calculated using equations (31) and (33) respectively. In step 414, the uniaxial stress at 3.3% plastic strain is calculated with equation (34). In step 416, reduced Young's modulus E* is then computed in step 416 using equation (35). If strain hardening exponent n is less than or equal to zero, it is taken as zero and in step 418 yield strength σ_{y} is estimated to be equal to the representative stress calculated in step 414. If strain hardening exponent n is greater than zero, the yield strength σ_{y} is computed with equation (5) in step 420.

### System for Implementing Algorithms

U.S. Pat. No. 6,134,954, issued Oct. 24, 2000 to Suresh, et al., entitled “Depth Sensing Mechanism and Methodology for Mechanical Property Measurements”, is incorporated herein by reference. U.S. Pat. No. 6,134,954 describes methodology, equipment and computer systems useful for performing indentation testing and analysis of indentation testing data. It is to be understood that all techniques described in U.S. Pat. No. 6,134,954, especially mechanical arrangements and equipment, can also be used in the context of the present invention. It is to be understood also that the present invention is defined not only by the claims that follow, but also by a combination of the following claims with all claims originally filed or added to the application that led to U.S. Pat. No. 6,134,954, where not inconsistent with claims or description filed herewith, as well as unclaimed subject matter in the description herewith.

The methods, steps, simulations, algorithms, systems, and system elements described above may be implemented using a computer implemented system, such as the various embodiments of computer implemented systems described below. The methods, steps, systems, and system elements described above are not limited in their implementation to any specific computer system described herein, as many other different machines may be used.

The computer implemented system can be part of or coupled in operative association with an indentation apparatus, and, in some embodiments, configured and/or programmed to control and direct an indentation test as well as analyze and calculate values. In some embodiments, the computer implemented system can send and receive control signals to set and/or control operating parameters of the apparatus. In other embodiments, the computer implemented system can be separate from and/or remotely located with respect to the indentation testing apparatus and may be configured to receive indentation testing data from one or more remote indentation testing devices via indirect and/or portable means, such as via portable electronic data storage devices, such as magnetic disks, or via communication over a computer network, such as the Internet or a local intranet.

The equations described for the various algorithms illustrated above do not need to be programmed directly into a computer or system used to perform the analysis. While the above algorithms have been illustrated with equations, look-up tables may alternatively be used to relate load-depth data to mechanical property values and/or vice-versa. Interpolation or extrapolation can be utilized in cases where exact look-up table values are not provided. Other methods of relating load-depth data to mechanical property values and vice-versa will be apparent to one of skill in the art and form part of the scope of the invention.

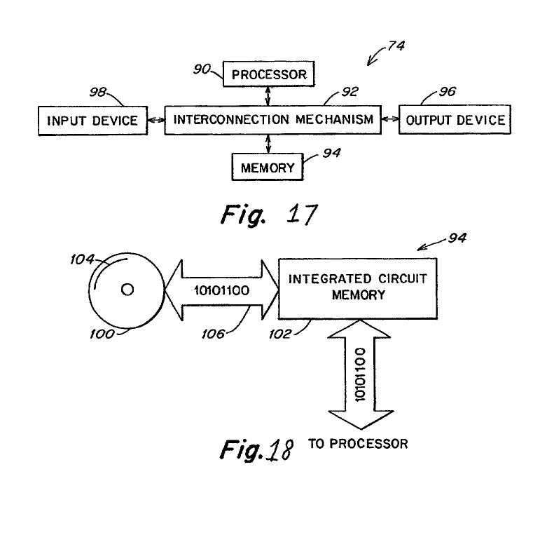

Referring to FIG. 17, such a computer system 74 may include several known components and circuitry, including a processing unit (i.e., processor 90), a memory system 94, input 98 and output 96 devices and interfaces (e.g., interconnection mechanism 92), as well as other components not specifically illustrated in FIG. 17, such as transport circuitry (e.g., one or more busses), a video and audio data input/output (I/O) subsystem, special-purpose hardware, as well as other components and circuitry, as described below in more detail. Further, the computer system may be a multi-processor computer system or may include multiple computers connected over a computer network.

The computer system may include a processor 90, for example, a commercially available processor such as one of the series x86, Celeron and Pentium processors, available from Intel, similar devices from AMD and Cyrix, the 680X0 series microprocessors available from Motorola, and the PowerPC microprocessor from IBM. Many other processors are available, and the computer system is not limited to a particular processor.

A processor typically executes a program called an operating system, of which WindowsNT, Windows95 or 98, UNIX, Linux, DOS, VMS, MacOS and OS8 are examples, which controls the execution of other computer programs and provides scheduling, debugging, input/output control, accounting, compilation, storage assignment, data management and memory management, communication control and related services. The processor and operating system together define a computer platform for which application programs in high-level programming languages are written. The computer system is not limited to a particular computer platform.

The computer system may include a memory system 94, which typically includes a computer readable and writeable non-volatile recording medium 100, of which a magnetic disk, optical disk, a flash memory and tape are examples. Such a recording medium may be removable, for example, a floppy disk, read/write CD or memory stick, or may be permanent, for example, a hard drive.

Such a recording medium stores signals, typically in binary form (i.e., a form interpreted as a sequence of one and zeros). A disk (e.g., magnetic or optical) has a number of tracks, as indicated at 104, on which such signals may be stored, typically in binary form, i.e., a form interpreted as a sequence of ones and zeros such as shown at 106. Such signals may define a software program, e.g., an application program, to be executed by the microprocessor, or information to be processed by the application program.

The memory system of the computer system also may include an integrated circuit memory element 102, which typically is a volatile, random access memory such as a dynamic random access memory (DRAM) or static memory (SRAM). Typically, in operation, the processor 90 causes programs and data to be read from the non-volatile recording medium 100 into the integrated circuit memory element 102, which typically allows for faster access to the program instructions and data by the processor 90 than does the non-volatile recording medium 100.

The processor 90 generally manipulates the data within the integrated circuit memory element 102 in accordance with the program instructions and then copies the manipulated data to the non-volatile recording medium 100 after processing is completed. A variety of mechanisms are known for managing data movement between the non-volatile recording medium 100 and the integrated circuit memory element 102, and the computer system that implements the methods, steps, systems and system elements described above in relation to FIGS. 17 and 18 is not limited thereto. The computer system is not limited to a particular memory system.

At least part of such a memory system described above may be used to store one or more of the data structures (e.g., look-up tables) or equations described above. For example, at least part of the non-volatile recording medium 100 may store at least part of a database that includes one or more of such data structures. Such a database may be any of a variety of types of databases, for example, a file system including one or more flat-file data structures where data is organized into data units separated by delimiters, a relational database where data is organized into data units stored in tables, an object-oriented database where data is organized into data units stored as objects, another type of database, or any combination thereof.

The computer system may include a video and audio data I/O subsystem. An audio portion of the subsystem may include an analog-to-digital (A/D) converter, which receives analog audio information and converts it to digital information. The digital information may be compressed using known compression systems for storage on the hard disk to use at another time. A typical video portion of the I/O subsystem may include a video image compressor/decompressor of which many are known in the art. Such compressor/decompressors convert analog video information into compressed digital information, and vice-versa. The compressed digital information may be stored on hard disk for use at a later time.

The computer system may include one or more output devices. Example output devices include a cathode ray tube (CRT) display, liquid crystal displays (LCD) and other video output devices, printers, communication devices such as a modem or network interface, storage devices such as disk or tape, and audio output devices such as a speaker.

The computer system also may include one or more input devices. Example input devices include a keyboard, keypad, track ball, mouse, pen and tablet, communication devices such as described above, and data input devices such as audio and video capture devices and sensors. The computer system is not limited to the particular input or output devices described herein.

The computer system may include specially programmed, special purpose hardware, for example, an application-specific integrated circuit (ASIC). Such special-purpose hardware may be configured to implement one or more of the methods, steps, simulations, algorithms, systems, and system elements described above.

The computer system and components thereof may be programmable using any of a variety of one or more suitable computer programming languages. Such languages may include procedural programming languages, for example, C, Pascal, Fortran and BASIC, object-oriented languages, for example, C++, Java and Eiffel and other languages, such as a scripting language or even assembly language.

The methods, steps, simulations, algorithms, systems, and system elements may be implemented using any of a variety of suitable programming languages, including procedural programming languages, object-oriented programming languages, other languages and combinations thereof, which may be executed by such a computer system. Such methods, steps, simulations, algorithms, systems, and system elements can be implemented as separate modules of a computer program, or can be implemented individually as separate computer programs. Such modules and programs can be executed on separate computers.

The methods, steps, simulations, algorithms, systems, and system elements described above may be implemented in software, hardware or firmware, or any combination of the three, as part of the computer system described above or as an independent component.

Such methods, steps, simulations, algorithms, systems, and system elements, either individually or in combination, may be implemented as a computer program product tangibly embodied as computer-readable signals on a computer-readable medium, for example, a non-volatile recording medium, an integrated circuit memory element, or a combination thereof. For each such method, step, simulation, algorithm, system, or system element, such a computer program product may comprise computer-readable signals tangibly embodied on the computer-readable medium that define instructions, for example, as part of one or more programs, that, as a result of being executed by a computer, instruct the computer to perform the method, step, simulation, algorithm, system, or system element.

Those skilled in the art would readily appreciate that all parameters listed herein are meant to be exemplary and that actual parameters will depend upon the specific application for which the methods and apparatus of the present invention are used. It is, therefore, to be understood that the foregoing embodiments are presented by way of example only and that, within the scope of the appended claims and equivalents thereto, the invention may be practiced otherwise than as specifically described. In the claims, all transitional phrases such as “comprising”, “including”, “carrying”, “having”, “containing”, “involving”, and the like are to be understood to be open-ended, i.e. to mean including but not limited to. Only the transitional phrases “consisting of” and “consisting essentially of”, respectively, shall be closed or semi-closed transitional phrases as set forth in MPEP section 2111.03.

The function and advantage of the embodiments described herein and recited in the claims that follow may be more fully understood from the examples below. The following examples are intended to illustrate certain aspects and features of certain embodiments of the present invention, but do not exemplify the full scope of the invention.

### EXAMPLE 1

### Comparison of Large Deformation Theory Based Computational Simulations with Experimental Results

As an illustration of the differences between utilizing large deformation theory simulation according to one embodiment of the invention and conventional small deformation theory simulation, results derived from example large deformation theory based computational simulations were compared with experimental results for two material samples. Two aluminum alloys were used in the present example: 6061-T6511 and 7075-T651 aluminum, both in the form of 2.54 cm diameter, extruded round bar stock. Two compression test specimens (0.5 cm diameter, 0.75 cm height) were machined from each bar such that the compression axis was parallel to the extrusion direction. Simple uniaxial compression tests were conducted on a servo-hydraulic universal testing machine at a crosshead speed of 0.2 mm/min. Crosshead displacement was obtained from a calibrated LVDT (linear voltage-displacement transducer). As each specimen was compressed to 45% engineering strain, the specimen ends were lubricated with polytetrafluoroethylene (TEFLON™) lubricant to prevent barreling. Intermittent unloading was conducted to allow for repeated measurement of Young's modulus and relubrication of the specimen ends. Recorded load-displacement data were converted to true stress-true strain data. Although the true stress-true strain responses were well approximated by power law fits, the experimental stress-strain data were used as direct input for FEM simulations, rather than the mathematical approximations. For 7075-T651 aluminum, the measured Young's modulus was E=70.1 GPa (v=0.33); and for 6061-T6511 aluminum, E=66.8 GPa (v=0.33).

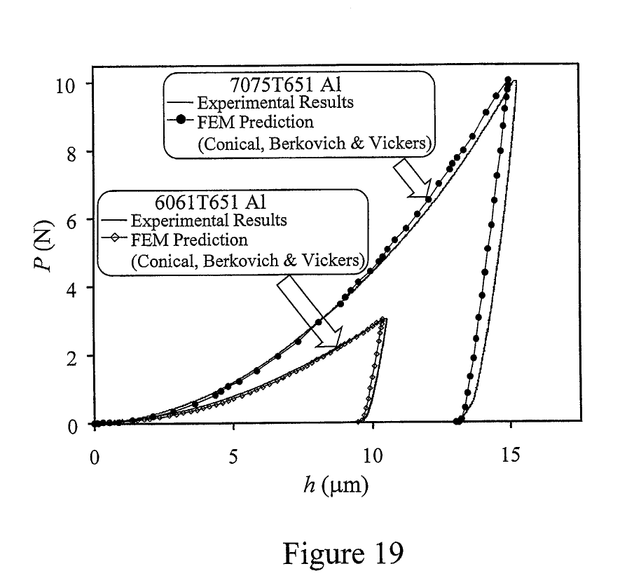

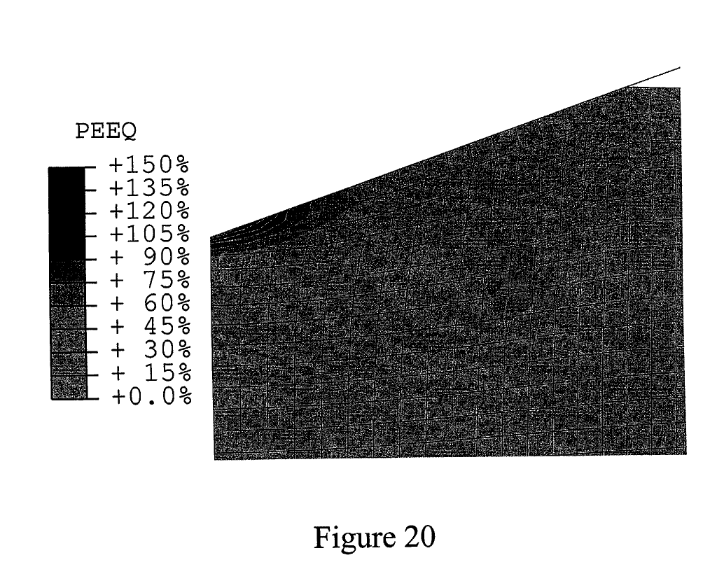

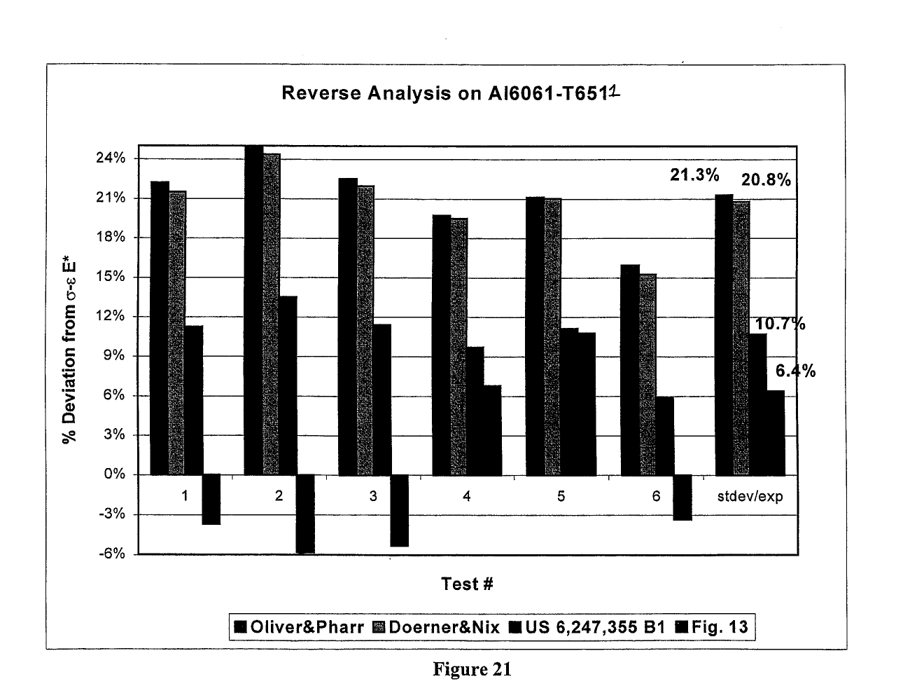

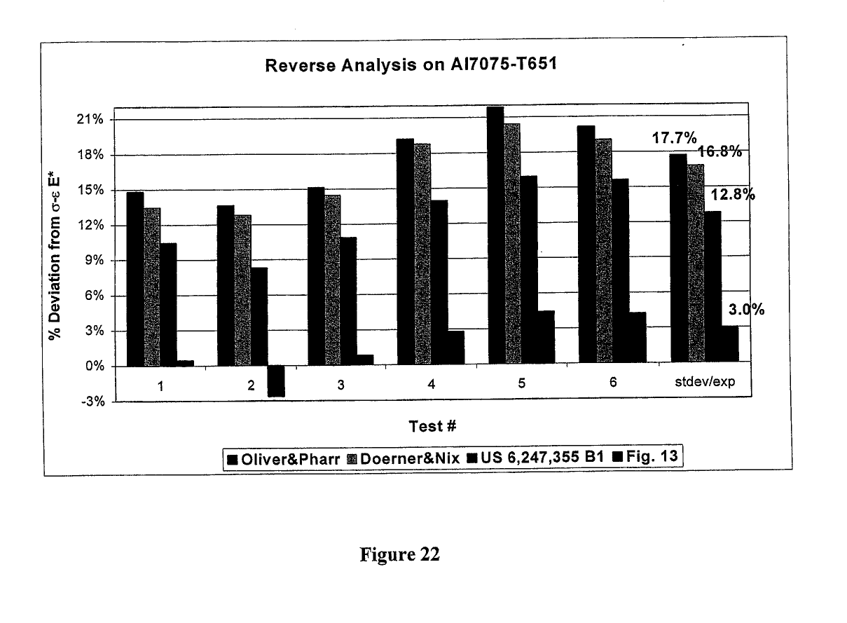

Indentation specimens were machined from the same round bar stock as discs of the bar diameter (3 mm thickness). Each specimen was polished to 0.06 μm surface finish with colloidal silica. These specimens were then indented on a commercial nanoindenter (MicroMaterials, Wrexham, UK) with a Berkovich diamond indenter at a loading/unloading rate of approximately 0.2 N/min. For each of three maximum loads (3, 10, and 20 N), five tests were conducted on two consecutive days, for a total of ten tests per load in each specimen. FIG. 19 shows the typical indentation responses of both the 7075-T651 aluminum and 6061-T6511 aluminum specimens, respectively. The corresponding finite element computations using conical, Berkovich and Vickers indenters are also plotted in FIG. 19. FIG. 20 shows the simulated equivalent plastic strain (PEEQ) within the 7075-T651 aluminum near the tip of the conical indenter, indicating that the majority of the material volume directly beneath the indenter experienced strains exceeding 15%. FIG. 20 also indicates that through much of the material volume the sample experienced strains exceeding 10%, 20%, 30%, 40%, 50%, 60%, 75%, and as much as 150%, which are accounted for in one embodiment of the inventive large deformation simulation methodology. Assuming only the σ−ε constitutive response obtained from experimental uniaxial compression, the computational P−h curves agree well with the experimental curves, as shown in FIG. 19. The computational P−h responses of the conical, Berkovich and Vickers indentations were found to be virtually identical for these two examples.

### EXAMPLE 2

### Predicting Indentation Behavior from Mechanical Property Values (Forward Algorithm)

To study the accuracy of the large deformation theory based algorithms provided by the invention, uniaxial compression and indentation experiments were conducted in two materials: 7075-T651 aluminum and 6061-T6511 aluminum. Values for E and σ_{y} were obtained from the resulting experimental true stress-true total strain data. The value for σ_{0.033} was then determined from the true stress-true plastic strain data. Finally, a power law equation was fit to the true stress-true plastic strain data to estimate a value for n (see Table 3). The Poisson ratio v was not experimentally determined, and was assigned a typical value of 0.33 for aluminum alloys. The parameters Eᵢ and vᵢ were assigned values of 1100 GPa and 0.07, respectively; these are typical values for diamond taken from the literature (MatWeb:http://www.matweb.com/, 2001, by Automation Creations, Inc.). Microhardness specimens were prepared identically to the microindentation specimens, and were indented on a commercial microhardness tester to a maximum load of 0.1 kgf over a total test time of 20 s. Vickers hardness was calculated as HV=1.8544P/D², where P is load (in kgf) and D is the average length of the indentation diagonals (in mm) as observed under an optical microscope with a 40× objective lens. The algorithm described in FIG. 12 was applied to solve for

$$C , \frac{{h}_{r}}{{h}_{m}} , {A}_{m} ,$$

$${p}_{ave} and \frac{ⅆ {P}_{u}}{ⅆ h} {\vert}_{{h}_{m}} .$$

Table 3 lists the mechanical property values used in the forward analysis. Tables 4(a) and 4(b) list the predictions from the forward analysis, along with the values actually determined from the experimental indentation data for 7075-T651 aluminum and 6061-T6511 aluminum specimens, respectively. The experimental values of

$$\frac{ⅆ {P}_{u}}{ⅆ h} {\vert}_{{h}_{m}}$$

listed in Tables 4(a) and 4(b) were obtained by first fitting a power law function Pᵤ=A(h−hᵣ)^{m} to 67% of the unloading data and then evaluating the derivative at h=hₘ. From Tables 4(a) and 4(b), it can be seen that the present forward analysis results are in generally good agreement with the experimental P−h curves.

TABLE 3
Mechanical property values used in the forward analysis

| | | | | | | n | | |
|---|---|---|---|---|---|---|---|---|
| | E | | E* | σ_{y} | σ_{y} | from power | Vickers | pₐᵥₑ |
| Material | (Gpa) | v | (GPa) | (GPa) | (GPa) | law fit | Hardness | (MPa) |
| A1 6061-T6511 | 66.8 | 0.33 | 70.2^{§} | 284^{&} | 338 | 0.08 | 104.7^{¶} | 1108^{#} |
| A1 7075-T651 | 70.1 | 0.33 | 73.4^{§} | 500^{&} | 617.5 | 0.122 | 174.1^{¶} | 1842^{#} |

^{§}Calculated from eq.(8) using Eᵢ = 1100 GPa and vᵢ = 0.07 for the diamond indenter.
^{&}Estimated at 0% offset strain.
^{≡}Averaged from 10 and 5 hardness tests (P = 0.1 kgf) for A1 6061-T6511 and A1 7075-T651 specimens, respectively.
^{#}Estimated from the hardness number assuming that changes in impression size during unloading can be ignored

TABLE 4(a)
Forward analysis results on Al 6061-T6511 (max. load = 3 N)

| Al 6061-T6511 | C (GPa) | % err C^{§} | ${\frac{ⅆ {P}_{u}}{ⅆ h} \vert}_{{h}_{m}} ( kN / m )$ | ${\% err \frac{ⅆ {P}_{u}}{ⅆ h} \vert}_{{h}_{m}}$ | Wₚ/Wₜ | % err WₚWₜ |
|---|---|---|---|---|---|---|
| Test 1 | 27.4 | −1.6% | 4768 | 1.6% | 0.902 | 0.8% |
| Test 2 | 28.2 | 1.2% | 4800 | 2.3% | 0.905 | 1.2% |
| Test 3 | 27.2 | −2.4% | 4794 | 2.2% | 0.904 | 1.1% |
| Test 4 | 27.3 | −2.2% | 4671 | −0.4% | 0.889 | −0.6% |
| Test 5 | 27.0 | −3.2% | 4762 | 1.5% | 0.889 | −0.6% |
| Test 6 | 27.6 | −0.9% | 4491 | −4.2% | 0.891 | −0.4% |
| Ave | 27.4 | | 4715 | | 0.896 | |
| STDEV^{%} | 0.6 | | 110.9 | | 0.007 | |
| STDEV/X_{prediction} | 2.1% | | 2.4% | | 0.8% | |
| Forward | 27.9 | | 4691 | | 0.894 | |
| Prediction | | | | | | |
| (assume ν = 0.33 | | | | | | |
| and Berkovich c*) | | | | | | |

${}^{§} All errors were computed as \frac{{X}_{test} - {X}_{prediction}}{{X}_{prediction}} ,$
where X represents a variable.
${}^{\%} STDEV = \sqrt{\frac{1}{N} {\sum }_{i = 1}^{N} {( {X}_{test} - {X}_{prediction} )}^{2}} ,$
where X represents a variable.

TABLE 4(b)
Forward analysis results on Al 7075-T651 (max. load = 3 N)

| Al 7075-T651 | C (GPa) | % err C^{§} | ${\frac{ⅆ {P}_{u}}{ⅆ h} \vert}_{{h}_{m}} ( kN / m )$ | ${\% err \frac{ⅆ {P}_{u}}{ⅆ h} \vert}_{{h}_{m}}$ | Wₚ/Wₜ | % err Wₚ/Wₜ |
|---|---|---|---|---|---|---|
| Test 1 | 42.0 | −4.2% | 3665 | 2.2% | 0.833 | 1.0% |
| Test 2 | 40.9 | −6.9% | 3658 | 2.1% | 0.838 | 1.7% |
| Test 3 | 42.3 | −3.7% | 3654 | 1.9% | 0.832 | 1.0% |
| Test 4 | 43.1 | −1.7% | 3744 | 4.5% | 0.836 | 1.5% |
| Test 5 | 43.5 | −0.7% | 3789 | 5.7% | 0.839 | 1.8% |
| Test 6 | 44.6 | 1.6% | 3706 | 3.4% | 0.831 | 0.9% |
| Ave | 42.7 | | 3703 | | 0.835 | |
| STDEV^{%} | 1.6 | | 128.1 | | 0.011 | |
| STDEV/X_{prediction} | 3.7% | | 3.6% | | 1.3% | |
| Forward | 43.9 | | 3585 | | 0.824 | |
| Prediction | | | | | | |
| (assume ν = 0.33 | | | | | | |
| and Berkovich c*) | | | | | | |

${}^{§} All errors were computed as \frac{{X}_{test} - {X}_{prediction}}{{X}_{prediction}} ,$
where X represents a variable.
${}^{\%} STDEV = \sqrt{\frac{1}{N} {\sum }_{i = 1}^{N} {( {X}_{test} - {X}_{prediction} )}^{2}} ,$
where X represents a variable.

### EXAMPLE 3

### Estimating Mechanical Property Values from Indentation Testing Data (Reverse Algorithm)

To study the reverse analysis algorithms, twelve experimental P−h data sets (six from 6061-T6511 aluminum specimens and six from 7075-T651 aluminum specimens) shown in Table 4 were analyzed to estimate elasto-plastic mechanical properties of the indented specimens. Results are shown in Tables 5(a) and 5(b). From Table 5(a) and 5(b), it can be seen that the inventive reverse algorithms yielded accurate estimates of E and σ_{0.033,} and gave reasonable estimates of σ_{y} (especially after taking an average from the six indentation results) which agree well with experimental compression data. It is noted that changing the definition of σ_{y} to 0.1% or 0.2% (instead of 0%) offset strain did not affect the conclusions. The average pressure pₐᵥₑ also compares well with values estimated from experimental microhardness tests. The fractional errors observed in obtaining n are artificially exaggerated because n<<1. Results presented in Tables 5(a)(1) and 5(b)(1) also show that the inventive reverse algorithms gave better predictions than the prior art small deformation theory based Oliver and Pharr and Doerner and Nix methods for estimating E* values. This improved calculation of elastic properties may be due to the fact that sink-in/pile-up effects were taken into account with present model, while they have been typically neglected in prior art determinations.

TABLE 5(a)(1)
Reverse Analysis on A1 6061-T6511 (max. load = 3 N; assume v = 0.3)

| | | | | | | | Method of Embodiment | |
|---|---|---|---|---|---|---|---|---|
| A1 6061- | Oliver&Pharr | | Doerner&Nix | | U.S. Pat. No. 6,247,355 B1 | | in FIG. 13 | |
| T6511 | E* (GPa) | % err E* | E* (GPa) | % err E* | E* (GPa) | % err E* | E* (GPa) | % err E* |
| Test 1 | 85.8 | 22.2%^{§} | 85.3 | 21.5% | 78.1 | 11.3% | 67.6 | −3.7% |
| Test 2 | 87.7 | 25.0% | 87.3 | 24.4% | 79.7 | 13.5% | 66.1 | −5.8% |
| Test 3 | 86.0 | 22.5% | 85.6 | 22.0% | 78.2 | 11.4% | 66.5 | −5.3% |
| Test 4 | 84.1 | 19.7% | 83.9 | 19.5% | 77.0 | 9.7% | 75.0 | 6.8% |
| Test 5 | 85.0 | 21.1% | 85.0 | 21.0% | 78.0 | 11.1% | 77.8 | 10.8% |
| Test 6 | 81.4 | 16.0% | 80.9 | 15.3% | 74.3 | 5.9% | 67.9 | −3.4% |
| Ave | 85.0 | | 84.7 | | 77.6 | | 70.1 | |
| STDEV^{%} | 14.9 | | 14.6 | | 7.5 | | 4.5 | |
| STDEV/Xₑₓₚ | 21.3% | | 20.8% | | 10.7% | | 6.5% | |

TABLE 5(a)(2)
Reverse Analysis on Al 6061-T6511 (max. load = 3 N; assume ν = 0.3)

| | σ_{0.033} | % err | | σ_{y} | % err | pₐᵥₑ | % err |
|---|---|---|---|---|---|---|---|
| Al 6061-T6511 | (MPa) | σ_{0.033} | n | (MPa) | σ_{y} | (MPa) | pₐᵥₑ |
| Test 1 | 334.5 | −1.0% | 0.002 | 333.1 | 17.3% | 904 | −18.4% |
| Test 2 | 349.4 | 3.4% | 0 | 349.4 | 23.0% | 849 | −23.4% |
| Test 3 | 332.8 | −1.5% | 0 | 332.8 | 17.2% | 860 | −22.4% |
| Test 4 | 322.9 | −4.5% | 0.234 | 171.0 | −39.8% | 1150 | 3.8% |
| Test 5 | 315.9 | −6.5% | 0.298 | 128.0 | −54.9% | 1198 | 8.1% |
| Test 6 | 337.4 | −0.2% | 0.088 | 278.5 | −1.9% | 1025 | −7.5% |
| Ave | 332.1 | | 0.104 | 265.5 | | 998 | |
| STDEV | 12.2 | | | 87.7 | | 176.5 | |
| STDEV/Xₑₓₚ | 3.6% | | | 30.9% | | 15.9% | |

${}^{§} All errors were computed as \frac{{X}_{rev . analysis} - {\overline{X}}_{exp}}{{\overline{X}}_{exp}} ,$
where X represents a variable.
${}^{\%} STDEV = \sqrt{\frac{1}{N} {\sum }_{i = 1}^{N} {( {X}_{rev . analysis} - {\overline{X}}_{exp} )}^{2}} ,$
where X represents a variable.

TABLE 5(b)(1)
Reverse Analysis on A1 7075-T651 (max. load = 3 N; assume v = 0.3)

| | | | | | | | Method of Embodiment | |
|---|---|---|---|---|---|---|---|---|
| A1 7075- | Oliver&Pharr | | Doerner&Nix | | U.S. Pat. No. 6,247,355 B1 | | in FIG. 13 | |
| T651 | E* (GPa) | % err E* | E* (GPa) | % err E* | E* (GPa) | % err E* | E* (GPa) | % err E* |
| Test 1 | 84.3 | 14.8%^{§} | 83.3 | 13.5% | 81.1 | 10.5% | 73.7 | 0.5% |
| Test 2 | 83.4 | 13.6% | 82.8 | 12.8% | 79.5 | 8.3% | 71.5 | −2.6% |
| Test 3 | 84.5 | 15.2% | 84.0 | 14.5% | 81.4 | 10.9% | 74.0 | 0.8% |
| Test 4 | 87.5 | 19.2% | 87.2 | 18.8% | 83.6 | 14.0% | 75.4 | 2.8% |
| Test 5 | 89.4 | 21.9% | 88.4 | 20.4% | 85.1 | 16.0% | 76.6 | 4.4% |
| Test 6 | 88.2 | 20.2% | 87.4 | 19.0% | 84.9 | 15.6% | 76.5 | 4.2% |
| Ave | 86.2 | | 85.5 | | 82.6 | | 74.6 | |
| STDEV^{%} | 13.0 | | 12.3 | | 9.4 | | 2.2 | |
| STDEV/Xₑₓₚ | 17.7% | | 16.8% | | 12.8% | | 3.0% | |

TABLE 5(b)(2)
Reverse Analysis on Al 7075-T651 (max. load = 3 N; assume ν = 0.3)

| | σ_{0.033} | % err | | σ_{y} | % err | pₐᵥₑ | % err |
|---|---|---|---|---|---|---|---|
| Al 7075-T651 | (MPa) | σ_{0.033} | n | (MPa) | σ_{y} | (MPa) | pₐᵥₑ |
| Test 1 | 579.3 | −6.2% | 0.130 | 457.1 | −8.6% | 1799 | −2.3% |
| Test 2 | 564.2 | −8.6% | 0.085 | 486.2 | −2.8% | 1656 | −10.1% |
| Test 3 | 583.2 | −5.6 | 0.132 | 458.2 | −8.4% | 1807 | −1.9% |
| Test 4 | 595.6 | −3.6% | 0.098 | 500.7 | 0.1% | 1780 | −3.4% |
| Test 5 | 599.6 | −2.9% | 0.088 | 513.4 | 2.7% | 1756 | −4.7% |
| Test 6 | 620.4 | 0.5% | 0.108 | 513.4 | 2.7% | 1870 | 1.5% |
| Ave | 590.4 | | 0.107 | 488.2 | | 1778 | |
| STDEV | 32.4 | | | 26.2 | | 91 | |
| STDEV/Xₑₓₚ | 5.2% | | | 5.3% | | 4.9% | |

${}^{§} All errors were computed as \frac{{X}_{rev . analysis} - {\overline{X}}_{exp}}{{\overline{X}}_{exp}} ,$
where X represents a variable.
${}^{\%} STDEV = \sqrt{\frac{1}{N} {\sum }_{i = 1}^{N} {( {X}_{rev . analysis} - {\overline{X}}_{exp} )}^{2}} ,$
where X represents a variable.

### EXAMPLE 4

### Reverse Algorithm without Calculating Area

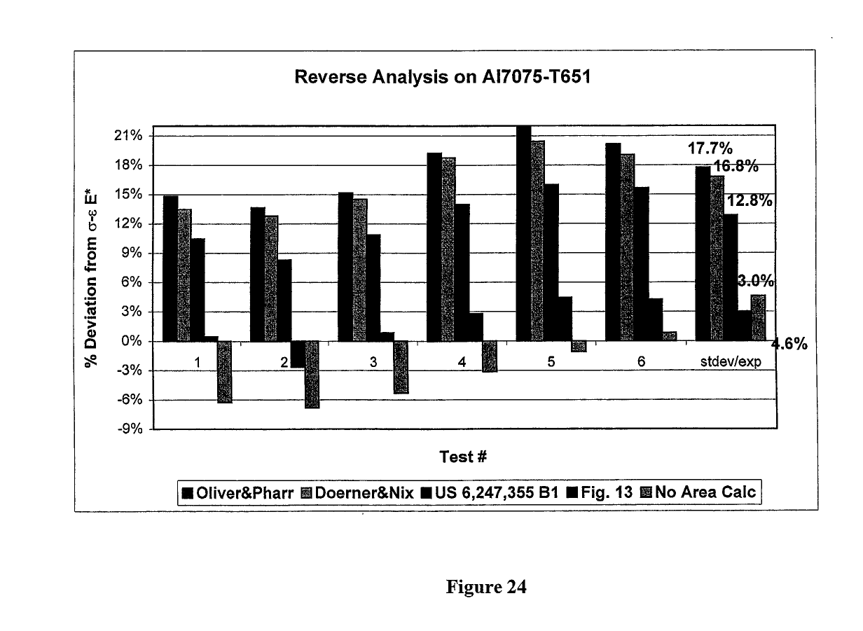

Twelve experimental P−h curves (six from 6061-T6511 aluminum specimens and six from 7075-T651 aluminum specimens) were analyzed to estimate elasto-plastic properties of the indented specimens using the algorithm shown in FIG. 14. FIGS. 23 and 24 compare the results of the analysis to four other method of estimating E* from indentation test data. From FIGS. 23 and 24, it can be seen that the estimated values of E* are in good agreement with the actual values of E*.

What is claimed is:

1. A method comprising:
providing data from at least one indentation test on a material; and
determining a value for at least one mechanical property of the material from the data, wherein in the determining step strains of at least 5% that are in the material under an area of contact are accounted for.

2. The method as recited in claim 1, wherein in the determining step strains of at least 10% that are in the material under an area of contact are accounted for.

3. The method as recited in claim 2, wherein in the determining step strains of at least 15% that are in the material under an area of contact are accounted for.

4. The method as recited in claim 3, wherein in the determining step strains of at least 20% that are in the material under an area of contact are accounted for.

5. The method as recited in claim 4, wherein in the determining step strains of at least 30% that are in the material under an area of contact are accounted for.

6. The method as recited in claim 5, wherein in the determining step strains of at least 40% that are in the material under an area of contact are accounted for.

7. The method as recited in claim 6, wherein in the determining step strains of at least 50% that are in the material under an area of contact are accounted for.

8. The method as recited in claim 7, wherein in the determining step strains of at least 60% that are in the material under an area of contact are accounted for.

9. The method as recited in claim 8, wherein in the determining step strains of at least 75% that are in the material under an area of contact are accounted for.

10. The method as recited in claim 1, further comprising:
performing a computational simulation of at least one indentation test on at least one material to develop simulated load-depth behavior data.

11. The method as recited in claim 10, further comprising:
fitting at least one mathematical equation to the simulated load-depth behavior data to develop at least one closed-form analytical equation correlating load-depth behavior to the at least one mechanical property.

12. The method as recited in claim 11, wherein the computational simulation comprises a finite element-based simulation or a boundary element analysis simulation of mechanical deformation based at least in part on large deformation theory.

13. The method as recited in claim 12, wherein the determining step involves calculating the at least one mechanical property from the data provided in the providing step with the at least one closed-form analytical equation.

14. The method as recited in claim 13, wherein the strain of at least 5% is accounted for via utilization of the computational simulation based at least in part on large deformation theory to develop the at least one closed form analytical equation used to determine the value for the at least one mechanical property in the determining step.

15. The method as recited in claim 1, wherein a value for the area of contact is determined in the determining step.

16. The method as recited in claim 1, wherein a value for a representative stress of the material is determined in the determining step.

17. The method as recited in claim 1, wherein a value for at least one mechanical property of the material selected from the group consisting of: Young's modulus; yield strength; and strain hardening exponent is determined in the determining step.

18. The method as recited in claim 17, wherein values for at least two mechanical properties of the material selected from the group consisting of: Young's modulus; yield strength; and strain hardening exponent are determined in the determining step.

19. The method as recited in claim 1, wherein values for Young's modulus, yield strength, and strain hardening exponent of the material are determined in the determining step.

20. The method as recited in claim 1, wherein a value for at least one elastic mechanical property is determined in the determining step.

21. The method as recited in claim 1, wherein a value for at least one elasto-plastic mechanical property is determined in the determining step.

22. The method as recited in claim 1, wherein a value for at least one plastic mechanical property is determined in the determining step.

23. The method as recited in claim 1, wherein a value for at least one non-elastic mechanical property is determined in the determining step.

24. The method as recited in claim 1, wherein the determining step utilizes relationships derived from a simulation of load-depth data based at least in part on large deformation theory.

25. A software product including a computer readable medium on which is encoded a sequence of software instructions which, when executed, direct performance of a method comprising:
determining a value for at least one mechanical property of a material from data provided from at least one indentation test on the material, wherein in the determination, strains of at least 5% that are in the material under an area of contact are accounted for.

26. The software product as recited in claim 25, wherein in the determining step strains of at least 10% that are in the material under an area of contact are accounted for.

27. The software product as recited in claim 26, wherein in the determining step strains of at least 20% that are in the material under an area of contact are accounted for.

28. The software product as recited in claim 27, wherein in the determining step strains of at least 30% that are in the material under an area of contact are accounted for.

29. The software product as recited in claim 28, wherein in the determining step strains of at least 40% that are in the material under an area of contact are accounted for.

30. The software product as recited in claim 29, wherein in the determining step strains of at least 50% that are in the material under an area of contact are accounted for.

31. The software product as recited in claim 30, wherein in the determining step strains of at least 60% that are in the material under an area of contact are accounted for.

32. A system comprising:
a computer implemented system configured to receive load and depth data from an indentation test involving an indentation testing apparatus that is configured to measure a contact load and a displacement between an indenter and a sample,
the computer implemented system being further configured to determine a value for at least one mechanical property of the material from the data by a process that accounts for strains of at least 5% under an area of contact between the material and the indenter.

33. The system as recited in claim 32, wherein the computer implemented system is further configured to:
perform a computational simulation of at least one indentation test on at least one material to develop simulated load-depth behavior data.

34. The system as recited in claim 33, wherein the computer implemented system is further configured to:
fit at least one mathematical equation to the simulated load-depth behavior data to develop at least one closed-form analytical equation correlating load-depth behavior to the at least one mechanical property.

35. The system as recited in claim 34, wherein the computational simulation comprises a finite element-based simulation or a boundary element analysis simulation of mechanical deformation based at least in part on large deformation theory.

36. The system as recited in claim 35, wherein the computer implemented system is configured to determine a value for the at least one mechanical property of the material from the load-depth data from the indentation testing apparatus by calculating the at least one mechanical property from the data from the indentation testing apparatus with the at least one closed-form analytical equation.

37. The system as recited in claim 32, further comprising:
the indentation testing apparatus that is configured to measure a contact load and a displacement between an indenter and a sample.

38. The system as recited in claim 37, wherein the indentation testing apparatus comprises:
a material sample mount;
an indenter;
a load measurement device configured to measure the contact load between the indenter and the sample; and
a depth measurement device configured to measure the depth of penetration of the indenter into the sample.

39. The system as recited in claim 32, wherein the computer system comprises:
an acquisition module having an input for receiving values of load and displacement from an indentation test on a material and an output; and
an analysis module having an input for receiving the values of load and displacement from the output of the acquisition module, and an output providing a signal indicative of a value for at least one mechanical property of the material, wherein the analysis module accounts for strains of at least 5% in an area of contact the between the material and the indenter.

40. The system as recited in claim 32, wherein the computer implemented system is further configured to compute: a first ratio of plastic work performed by an indenter after a loading and unloading to total work performed by an indenter after loading; and
a second ratio of residual indentation to measure maximum indentation depth; wherein the second ratio is computed from the first ratio by using a closed-form equation developed with a computational simulation of load-depth behavior.

41. A method for facilitating the determination of at least one mechanical property of a material comprising:
providing a computer implemented system configured to receive load and depth data from an indentation test involving an indentation testing apparatus and to determine a value for the at least one mechanical property of the material from the data by a process that accounts for strains of at least 5% in an area of contact the between the material and the indenter.

42. A method for facilitating the determination of at least one mechanical property of a material comprising:
providing a software product including a computer readable medium on which is encoded a sequence of software instructions which, when executed, direct the computer to receive load and depth data from an indentation testing apparatus and to determine a value for the at least one mechanical property of the material from the data by a process that accounts for strains of at least 5% in an area of contact the between the material and the indenter.

43. A method comprising:
providing at least one mechanical property value for a material; and determining load-depth data that can be used to predict load-depth behavior during a loading and unloading cycle for an indentation test on a sample of material having the at least one mechanical property value, wherein in the determining step strains of at least 5% that are in the material under an area of contact are accounted for.

44. A software product including a computer readable medium on which is encoded a sequence of software instructions which, when executed, direct performance of a method comprising:
determining load-depth data that can be used to predict load-depth behavior during a loading and unloading cycle for an indentation test on a sample of material having at least one predetermined mechanical property value, wherein in the determination, strains of at least 5% that are in the material under an area of contact are accounted for.

45. A method comprising:
providing data from at least one indentation test on a material; and
determining a value for at least one mechanical property of the material from the data, the determining step utilizing relationships derived from a simulation of load-depth data based at least in part on large deformation theory.

46. The method as recited in claim 45, further comprising:
performing a computational simulation of at least one indentation test on at least one material to develop simulated load-depth behavior data.

47. The method as recited in claim 46, further comprising:
fitting at least one mathematical equation to the simulated load-depth behavior data to develop at least one closed-form analytical equation correlating load-depth behavior to the at least one mechanical property.

48. The method as recited in claim 47, wherein the computational simulation comprises a finite element-based simulation or a boundary element analysis simulation of mechanical deformation based at least in part on large deformation theory.

49. The method as recited in claim 48, wherein the determining step involves calculating the at least one mechanical property from the data provided in the providing step with the at least one closed-form analytical equation.

50. A software product including a computer readable medium on which is encoded a sequence of software instructions which, when executed, direct performance of a method comprising:
determining a value for at least one mechanical property of a material from data from at least one indentation test on the material, wherein the determination utilizes relationships derived from a simulation of load-depth data based at least in part on large deformation theory.

51. A system comprising
a computer implemented system configured to accept load and depth data from an indentation test involving an indentation testing apparatus that is configured to measure a contact load and depth between an indenter and a sample,
the computer implemented system being further configured to determine a value for at least one mechanical property of the material from the data by a process that utilizes relationships derived from a simulation of load-depth data based at least in part on large deformation theory.

52. The system as recited in claim 51, wherein the computer implemented system is further configured to:
perform a computational simulation of at least one indentation test on at least one material to develop simulated load-depth behavior data.

53. The system as recited in claim 52, wherein the computer implemented system is further configured to:
fit at least one mathematical equation to the simulated load-depth behavior data to develop at least one closed-form analytical equation correlating load-depth behavior to the at least one mechanical property.

54. The system as recited in claim 53, wherein the computational simulation comprises a finite element-based simulation or a boundary element analysis simulation of mechanical deformation based at least in part on large deformation theory.

55. The system as recited in claim 54, wherein the computer implemented system is configured to determine a value for the at least one mechanical property of the material from the load-depth data from the indentation testing apparatus by calculating the at least one mechanical property from the data from the indentation testing apparatus with the at least one closed-form analytical equation.

56. The system as recited in claim 51, further comprising:
the indentation testing apparatus that is configured to measure a contact load and depth between an indenter and a sample.

57. The system as recited in claim 56, wherein the indentation testing apparatus comprises:
a material sample mount;
an indenter;
a load measurement device configured to measure a contact load between the indenter and a material sample; and
a depth measurement device configured to measure the depth of penetration of the indenter into the material sample.

58. A method comprising:
providing at least one mechanical property value for a material; and
determining load-depth data that can be used to predict load-depth behavior during a loading and unloading cycle for an indentation test on a sample of material having the at least one mechanical property value, wherein the determining step utilizes relationships derived from a simulation of load-depth data based at least in part on large deformation theory.

59. A method comprising:
providing data from at least one indentation test in which a contact load is applied between a sample of material and an indenter over an area of contact; and
determining a value for at least one mechanical property of the material without calculating or measuring the area of contact.

60. A method comprising:
providing at least one mechanical property value of a material; and
determining load-depth data that can be used to predict load-depth behavior during a loading and unloading cycle for an indentation test in which load is applied over an area of contact to a sample of material having the at least one mechanical property value without calculating or measuring the area of contact.

61. A method comprising:
providing data from at least one indentation test on a material; and
determining an estimated value of yield strength from the data, wherein the estimated value differs from an actual value of yield strength for the material by a factor of no greater than two.

62. The method as recited in claim 61, wherein the estimated value differs from an actual value of yield strength for the material by no more than 75%.

63. The method as recited in claim 61, wherein the estimated value differs from an actual value of yield strength for the material by no more than 50%.

64. The method as recited in claim 61, wherein the estimated value differs from an actual value of yield strength for the material by no more than 25%.

65. The method as recited in claim 61, wherein the estimated value differs from an actual value of yield strength for the material by no more than 10%.

66. The method as recited in claim 61, wherein the estimated value differs from an actual value of yield strength for the material by no more than 5%.

67. The method as recited in claim 61, wherein the estimated value differs from an actual value of yield strength for the material by no more than 1%.

68. The method recited in claim 65, wherein the estimated value is an average of values determined from data of at least two indentation tests.

69. The method recited in claim 66, wherein the estimated value is an average of values determined from data of at least two indentation tests.

70. A software product including a computer readable medium on which is encoded a sequence of software instructions which, when executed, direct performance of a method comprising:
determining an estimated value of yield strength from data provided from an indentation test on a material, wherein the estimated value differs from an actual value of yield strength for the material by a factor of no greater than two.

71. The software product recited in claim 70, wherein the estimated value differs from an actual value of yield strength for the material by no more than 25%.

72. The software product recited in claim 70, wherein the estimated value differs from an actual value of yield strength for the material by no more than 5%.

73. The method recited in claim 71, wherein the estimated value is an average of values determined from data of at least two indentation tests.
